(19) United States
(12) Patent Application Publication
(10) Pub. No.: US 2024/0077586 A1
(43) Pub. Date: Mar. 7, 2024

(54) METHOD FOR GENERATING INTENSITY INFORMATION HAVING EXTENDED EXPRESSION RANGE BY REFLECTING GEOMETRIC CHARACTERISTIC OF OBJECT, AND LIDAR APPARATUS PERFORMING SAME METHOD

(71) Applicant: SOS LAB CO., LTD., Gwangju (KR)

(72) Inventors: Yong Yi LEE, Seongnam-si, Gyeonggi-do (KR); Junho CHOI, Gwangju (KR); Dongwon SHIN, Gwangju (KR); Deokyun JANG, Gwangju (KR); Jun Hwan JANG, Suwon-si, Gyeonggi-do (KR)

(21) Appl. No.: 18/263,111

(22) PCT Filed: Jan. 28, 2022
(86) PCT No.: PCT/KR2022/001672

§ 371 Date: Jul. 26, 2023

(30) Foreign Application Priority Data
Jan. 29, 2021 (KR) 10-2021-0013696
Jun. 25, 2021 (KR) 10-2021-0083129

(51) Int. Cl. G01S 7/48; G01S 17/89; G06T 7/60; G06T 7/73; G06T 17/00

(52) U.S. Cl. CPC G01S 7/4802; G01S 17/89; G06T 7/60; G06T 7/73; G06T 17/00; G06T 2207/10028; G06T 2210/56

(57) ABSTRACT

A method for processing point data obtained from a light detection and ranging (LiDAR) device is proposed. The method may include obtaining point cloud data including a plurality of point data for a plurality of detection points. The method may also include generating an image of the plurality of detection points based on the point cloud data. Each of the plurality of point data may include location information about a detection point and a geometrically enhanced intensity of the detection point. The geometrically enhanced intensity may be generated based on a combination of a reflection parameter related to the amount of light scattered at the detection point and a geometric parameter based on geometrical characteristic of the detection point.

### TECHNICAL FIELD

The present disclosure relates to a LiDAR device for generating an image with an extended expression range on the basis of intensity information including a geometrically enhanced intensity. More particularly, the present disclosure relates to a LiDAR device that generates a geometrically enhanced intensity by reinforcing a raw intensity obtained from a detection signal generated on the basis of a laser reflected by an object, with a parameter reflecting a geometrical characteristic of the object, thereby visualizing the object close to reality.

### BACKGROUND ART

A LiDAR device may obtain shape information and reflection intensity information for a surrounding environment in real time through the flight time of a laser and the intensity of a laser that is reflected by an object and returns. In particular, the LiDAR device may generate a detection signal by receiving a laser reflected by an object and may process the detection signal to obtain a raw-intensity value for a detection point.

Reflection intensity information for an object obtained by the LiDAR device determines a visual characteristic, such as brightness or shade, of the object in visualizing the object by the LiDAR device. However, an intensity value obtained by the LiDAR device is unable to effectively reveal the visual characteristic of the object because of a limited operating range of a LiDAR receiver.

Accordingly, recently, research on finding intrinsic reflection intensity information of an object has been widely conducted. However, there are still limitations in reflecting an intrinsic property of an object through intensity information or in visualizing an object in an image close to reality.

### DISCLOSURE

### Technical Problem

An object of the present disclosure relates to a LiDAR device for generating intensity information that reflects both a geometrical characteristic and a reflection characteristic of an object.

An object of the present disclosure relates to a LiDAR device for obtaining intensity information with an extended expression range through normalization of a numerical range.

An object of the present disclosure relates to a LiDAR device for generating an intensity image by using intensity information obtained by enhancing a geometrical characteristic of an object.

### Technical Solution

According to an embodiment, A method for processing point data obtained from a LiDAR(Light Detection and Ranging) device, comprising: obtaining a point cloud data including a plurality of point data for a plurality of detection point and generating an image for the plurality of detection point based on the point cloud data, wherein each of the plurality of point data comprising: a location information for a detection point and geometrically enhanced intensity for the detection point, wherein the geometrically enhanced intensity is generated based on a combination of a reflection parameter related to an amount of light scattered at the detection point and a geometrical parameter based on a geometrical characteristic of the detection point, wherein the reflection parameter is obtained based on a detection signal generated by the LiDAR device based on at least a part of the light scattered at the detection point, wherein the geometrical characteristic is obtained based on a location information for a group of detection point determined based on the location information for the detection point, wherein the group of detection point includes the detection point and at least a part of other detection point around the detection point, wherein the geometrically enhanced intensity is proportional to the reflection parameter and the geometrical parameter.

In addition, according to an embodiment, A method for processing point data obtained from a LiDAR(Light Detection and Ranging) device, comprising: obtaining a location information for a detection point, for the detection point, obtaining a first intensity based on a detection signal corresponding to the detection point, for the detection point, generating a second intensity based on a location information for a group of detection point determined based on the location information for the detection point and for the detection point, generating a third intensity based on a combination of the first intensity and the second intensity, wherein the third intensity is proportional to the first intensity and the second intensity.

In addition, according to an embodiment, a method for processing point data obtained from a LiDAR(Light Detection and Ranging) device, comprising: obtaining a location information for a detection point, for the detection point, obtaining a first intensity based on a detection signal corresponding to the detection point, for the detection point, generating a second intensity based on a location information for a group of detection point determined based on the location information for the detection point and for the detection point, generating a third intensity based on a combination of the first intensity and the second intensity, wherein the first intensity and the second intensity are normalized based on the same numerical range.

In addition, according to embodiment, a computer-readable recording medium for performing the method can be provided.

However, the solving means of the problems of the present disclosure are not limited to the aforementioned solving means and other solving means which are not mentioned will be clearly understood by those skilled in the art from the present specification and the accompanying drawings.

### Advantageous Effects

According to the present disclosure, a LiDAR device for generating intensity information that reflects both a geometrical characteristic and a reflection characteristic of an object can be provided.

According to the present disclosure, a LiDAR device for obtaining intensity information with an extended expression range through normalization of a numerical range can be provided.

According to the present disclosure, a LiDAR device for generating an intensity image by using intensity information obtained by enhancing a geometrical characteristic of an object can be provided.

The effects of the present disclosure are not limited to the aforementioned effects and other effects which are not mentioned will be clearly understood by those skilled in the art from the present specification and the accompanying drawings.

### DESCRIPTION OF DRAWINGS

FIG. 1 is a diagram illustrating a LiDAR device according to an embodiment.

FIG. 2 is a diagram illustrating an SPAD array according to an embodiment.

FIG. 3 is a diagram illustrating a histogram of an SPAD according to an embodiment.

FIG. 4 is a diagram illustrating functions of a LiDAR device including a scanner according to an embodiment.

FIG. 5 is a diagram illustrating a LiDAR device including a detecting unit according to an embodiment.

FIG. 6 is a diagram illustrating a method of obtaining information on the basis of a detection signal generated by a detecting unit according to an embodiment.

FIG. 7 is a diagram illustrating data displayed on a 3D map, the data being obtained by a LiDAR device.

FIG. 8 is a diagram illustrating a point cloud simply displayed on a 2D plane.

FIG. 9 is a diagram illustrating point data obtained from a LiDAR device according to an embodiment.

FIG. 10 is a diagram illustrating a point data set obtained from a LiDAR device.

FIG. 11 is a diagram illustrating a plurality of pieces of information included in property data according to an embodiment.

FIG. 12 is a flowchart illustrating a method of generating an image on the basis of point cloud data generated by a LiDAR device according to an embodiment.

FIG. 13 is a diagram illustrating a configuration of a LiDAR device for generating point data according to an embodiment.

FIG. 14 is a diagram illustrating location information included in point data according to an embodiment.

FIG. 15 is a diagram illustrating intensity information according to an embodiment.

FIG. 16 is a diagram illustrating a method of storing intensity information according to an embodiment.

FIG. 17 is a flowchart illustrating a method of generating a raw intensity by a LiDAR device according to an embodiment.

FIG. 18 is a diagram illustrating change in a raw intensity depending on distance information between a LiDAR device according to an embodiment and a detection point.

FIG. 19 is a diagram illustrating a difference between detection signals generated for detection points at different distances by the LiDAR device of FIG. 18.

FIG. 20 is a diagram illustrating change in a raw intensity depending on an incident angle of a laser emitted to a detection point by a LiDAR device according to an embodiment.

FIG. 21 is a diagram illustrating change in a raw intensity depending on a property of an object to which a laser is emitted by a LiDAR device according to an embodiment.

FIG. 22 is a diagram illustrating a correlation between a raw intensity generated by a LiDAR device according to an embodiment and information reflected by the raw intensity.

FIG. 23 is a flowchart illustrating a method of generating a corrected intensity by a LiDAR device according to an embodiment.

FIG. 24 is a diagram illustrating a raw intensity and a corrected intensity obtainable for a detection point by a LiDAR device according to an embodiment.

FIG. 25 is a flowchart illustrating a method of generating a geometrically enhanced intensity by a LiDAR device according to an embodiment.

FIG. 26 is a flowchart illustrating a method of generating a reflection parameter by a LiDAR device according to an embodiment.

FIG. 27 is a flowchart illustrating a method of generating a geometrical parameter by a LiDAR device according to an embodiment.

FIG. 28 is a diagram illustrating a geometrical characteristic of a detection point determined by a LiDAR device according to an embodiment.

FIG. 29 is a flowchart illustrating a method of determining a geometrical characteristic by a LiDAR device according to an embodiment.

FIG. 30 is a diagram illustrating a method of generating a geometrical parameter by a LiDAR device according to an embodiment.

FIG. 31 is a diagram illustrating a method of generating a geometrically enhanced intensity by a controller of a LiDAR device according to an embodiment.

FIG. 32 is a diagram illustrating a feature of a point cloud image generated by a LiDAR device according to an embodiment on the basis of intensity information including a geometrically enhanced intensity.

FIG. 33 is a diagram illustrating comparison of point cloud images generated on the basis of various types of intensity information by a LiDAR device according to an embodiment.

FIG. 34 is a diagram illustrating sensitivity of intensity values to an incident angle that are included in intensity information generated by a LiDAR device according to an embodiment.

FIG. 35 is a flowchart illustrating a method of generating a 2D image by a LiDAR device according to an embodiment.

FIG. 36 is a diagram illustrating a method of generating an image with a spherical projection method by a LiDAR device according to an embodiment.

FIG. 37 is a diagram illustrating that a LiDAR device according to an embodiment generates a 2D image.

FIG. 38 is a diagram illustrating that a LiDAR device according to an embodiment determines pixel data for generating an image.

FIG. 39 is a flowchart illustrating a method of generating an image by a LiDAR device according to another embodiment.

FIG. 40 is a flowchart illustrating a method of correcting distance information on the basis of intensity information by an LiDAR device according to an embodiment.

### BEST MODE

Embodiments described in this specification are intended to clearly explain the spirit of the invention to those skilled in the art. Therefore, the present invention is not limited by the embodiments, and the scope of the present invention should be interpreted as encompassing modifications and variations without departing from the spirit of the invention.

Terms used in this specification are selected from among general terms, which are currently widely used, in consideration of functions in the present invention and may have meanings varying depending on intentions of those skilled in the art, customs in the field of the art, the emergence of new technologies, or the like. If a specific term is used with a specific meaning, the meaning of the term will be described specifically. Accordingly, the terms used in this specification should not be defined as simple names of the components but should be defined on the basis of the actual meaning of the terms and the whole context throughout the present specification.

The accompanying drawings are to facilitate the explanation of the present invention, and the shape in the drawings may be exaggerated for the purpose of convenience of explanation, so the present invention should not be limited by the drawings.

When it is determined that detailed descriptions of well-known elements or functions related to the present invention may obscure the subject matter of the present invention, detailed descriptions thereof will be omitted herein as necessary.

According to an embodiment, A method for processing point data obtained from a LiDAR(Light Detection and Ranging) device, comprising: obtaining a point cloud data including a plurality of point data for a plurality of detection point and generating an image for the plurality of detection point based on the point cloud data, wherein each of the plurality of point data comprising: a location information for a detection point and geometrically enhanced intensity for the detection point, wherein the geometrically enhanced intensity is generated based on a combination of a reflection parameter related to an amount of light scattered at the detection point and a geometrical parameter based on a geometrical characteristic of the detection point, wherein the reflection parameter is obtained based on a detection signal generated by the LiDAR device based on at least a part of the light scattered at the detection point, wherein the geometrical characteristic is obtained based on a location information for a group of detection point determined based on the location information for the detection point, wherein the group of detection point includes the detection point and at least a part of other detection point around the detection point, wherein the geometrically enhanced intensity is proportional to the reflection parameter and the geometrical parameter.

Herein, the location information for the detection point reflects a distance between the LiDAR device and the detection point.

In addition, the location information for the detection point is generated based on a detection time point of the detection signal and a light emission time point of the LiDAR device.

In addition, the reflection parameter is obtained based on a characteristic of the detection signal, wherein the characteristic of the detection signal includes at least one of a pulse width of the detection signal, a rising edge of the detection signal, a falling edge of the detection signal and a pulse area of the detection signal.

In addition, the detection signal is generated by detecting at least a portion of laser scattered at the detection point when the laser emitted from the LiDAR device reaches the detection point.

In addition, the geometrical characteristic of the detection point is generated based on a normal vector corresponding to a virtual plane, wherein the virtual plane is formed based on the location information of the group of detection point.

In addition, the geometrical characteristic of the detection point reflects a geometrical shape formed by the group of detection point.

In addition, the geometrical parameter is obtained based on the geometrical characteristic and a direction vector of laser emitted from the LiDAR device towards the detection point.

In addition, the reflection parameter depends on an intrinsic property of the detection point and a distance between the LiDAR device and the detection point.

In addition, the combination of the reflection parameter and the geometrical parameter is performed such that a numerical range of the geometrically enhanced intensity is equal to a numerical range of the reflection parameter.

In addition, the reflection parameter and the geometrical parameter is normalized based on the same numerical range.

In addition, the combination of the reflection parameter and the geometrical parameter is a linear combination of the reflection parameter and the geometrical parameter.

In addition, the combination of the reflection parameter and the geometrical parameter is performed by assigning a weight to each of the reflection parameter and the geometrical parameter.

In addition, a weight for the reflection parameter and a weight for the geometrical parameter is determined such that a sum of the weight for the reflection parameter and the weight for the geometrical parameter is constant.

In addition, each of a weight for the reflection parameter and a weight for the geometrical parameter is determined based on a property information of a set of point data including a point data for the detection point.

In addition, the image includes a plurality of pixel data corresponding to the plurality of point data, wherein a pixel coordinate of each of the plurality of pixel data is determined based on the location information of each of the plurality of point data, wherein a pixel value of each of the plurality of pixel data is determined based on the geometrically enhanced intensity of each of the plurality of point data.

In addition, the generation of the image is comprising: projecting the point data of the detection point to a pixel data, wherein a value of the pixel data is corresponding to the geometrically enhanced intensity, generating the image including a plurality of pixel data by performing the projection for each of the plurality of point data for the plurality of detection point.

In addition, according to an embodiment, A method for processing point data obtained from a LiDAR(Light Detection and Ranging) device, comprising: obtaining a location information for a detection point, for the detection point, obtaining a first intensity based on a detection signal corresponding to the detection point, for the detection point, generating a second intensity based on a location information for a group of detection point determined based on the location information for the detection point and for the detection point, generating a third intensity based on a combination of the first intensity and the second intensity, wherein the third intensity is proportional to the first intensity and the second intensity.

Herein, the location information for the detection point and the third intensity is used to generate an image for a plurality of detection point including the detection point.

In addition, according to an embodiment, a method for processing point data obtained from a LiDAR(Light Detection and Ranging) device, comprising: obtaining a location information for a detection point, for the detection point, obtaining a first intensity based on a detection signal corresponding to the detection point, for the detection point, generating a second intensity based on a location information for a group of detection point determined based on the location information for the detection point and for the detection point, generating a third intensity based on a combination of the first intensity and the second intensity, wherein the first intensity and the second intensity are normalized based on the same numerical range.

In addition, according to embodiment, a computer-readable recording medium for performing the method can be provided.

Hereinafter, a LiDAR device of the present disclosure will be described.

1. LiDAR Device

A LiDAR device is a device for detecting a distance to an object and the location of an object using a laser. For example, a LiDAR device may emit a laser beam. When the emitted laser beam is reflected by an object, the LiDAR device may receive the reflected laser beam and measure a distance between the object and the LiDAR device and the location of the object. In this case, the distance from the object and the location of the object may be expressed in a coordination system. For example, the distance from the object and the location of the object may be expressed in a spherical coordinate system (r, 0, (p). However, the present disclosure is not limited thereto, and the distance and location may be expressed in a Cartesian coordinate system (X, Y, Z) or a cylindrical coordinate system (r, 0, z).

Also, the LiDAR device may use laser beams output from the LiDAR device and reflected by an object in order to measure a distance from the object.

The LiDAR device according to an embodiment may use a time of flight (TOF) of a laser beam, which is the time taken by a laser beam to be detected after being emitted, in order to measure the distance from the object. For example, the LiDAR device may measure the distance from the object using a difference between a time value based on an emitting time of an emitted laser beam and a time value based on a detection time of a detected laser beam reflected by the object.

Also, the LiDAR device may measure the distance from the object using a difference between a time value at which an emitted laser beam is detected immediately without reaching an object and a time value based on a detection time of a detected laser beam reflected by the object.

There may be a difference between a time point at which the LiDAR device transmits a trigger signal for emitting a laser beam using a control unit and an actual emission time point, which is a time when the laser beam is actually emitted from a laser beam output element. Actually, no laser beam is emitted in a period between the time point of the trigger signal and the actual emission time point. Thus, when the period is included in the ToF of the laser beam, precision may be decreased.

The actual emission time point of the laser beam may be used to improve the precision of the measurement of the TOF of the laser beam. However, it may be difficult to determine the actual emission time point of the laser beam. Therefore, a laser beam should be directly delivered to a detecting unit as soon as or immediately after the laser beam is emitted from the laser emitting element without reaching the object.

For example, an optic may be disposed on an upper portion of the laser emitting element, and thus the optic may enable a laser beam emitted from the laser emitting element to be detected by a detecting unit immediately without reaching an object. The optic may be a mirror, a lens, a prism, a metasurface, or the like, but the present disclosure is not limited thereto. The optic may include one optic or a plurality of optics.

Also, for example, a detecting unit may be disposed on an upper portion of the laser emitting element, and thus a laser beam emitted from the laser emitting element may be detected by the detecting unit immediately without reaching an object. The detecting unit may be spaced a distance of 1 mm, 1 μm, 1 nm, or the like from the laser emitting element, but the present disclosure is not limited thereto. Alternatively, the detecting unit may be adjacent to the laser emitting element with no interval therebetween. An optic may be present between the detecting unit and the laser emitting element, but the present disclosure is not limited thereto.

Also, the LiDAR device according to an embodiment may use a triangulation method, an interferometry method, a phase shift measurement, and the like rather than the TOF method to measure a distance to an object, but the present disclosure is not limited thereto.

A LiDAR device according to an embodiment may be installed in a vehicle. For example, the LiDAR device may be installed on a vehicle's roof, hood, headlamp, bumper, or the like.

Also, a plurality of LiDAR devices according to an embodiment may be installed in a vehicle. For example, when two LiDAR devices are installed on a vehicle's roof, one LiDAR device is for monitoring an area in front of the vehicle, and the other one is for monitoring an area behind the vehicle, but the present disclosure is not limited thereto. Also, for example, when two LiDAR devices are installed on a vehicle's roof, one LiDAR device is for monitoring an area to the left of the vehicle, and the other one is for monitoring an area to the right of the vehicle, but the present disclosure is not limited thereto.

Also, the LiDAR device according to an embodiment may be installed in a vehicle. For example, when the LiDAR device is installed in a vehicle, the LiDAR device is for recognizing a driver's gesture while driving, but the present disclosure is not limited thereto. Also, for example, when the LiDAR device is installed inside or outside a vehicle, the LiDAR device is for recognizing a driver's face, but the present disclosure is not limited thereto.

A LiDAR device according to an embodiment may be installed in an unmanned aerial vehicle. For example, the LiDAR device may be installed in an unmanned aerial vehicle (UAV) System, a drone, a remotely piloted vehicle (RPV), an unmanned aircraft system (UAS), a remotely piloted air/aerial vehicle (RPAV), a remotely piloted aircraft system (RPAS), or the like.

Also, a plurality of LiDAR devices according to an embodiment may be installed in an unmanned aerial vehicle. For example, when two LiDAR devices are installed in an unmanned aerial vehicle, one LiDAR device is for monitoring an area in front of the unmanned aerial vehicle, and the other one is for monitoring an area behind the unmanned aerial vehicle, but the present disclosure is not limited thereto. Also, for example, when two LiDAR devices are installed in an unmanned aerial vehicle, one LiDAR device is for monitoring an area to the left of the aerial vehicle, and the other one is for monitoring an area to the right of the aerial vehicle, but the present disclosure is not limited thereto.

A LiDAR device according to an embodiment may be installed in a robot. For example, the LiDAR device may be installed in a personal robot, a professional robot, a public service robot, or other industrial robots or manufacturing robots.

Also, a plurality of LiDAR devices according to an embodiment may be installed in a robot. For example, when two LiDAR devices are installed in a robot, one LiDAR device is for monitoring an area in front of the robot, and the other one is for monitoring an area behind the robot, but the present disclosure is not limited thereto. Also, for example, when two LiDAR devices are installed in a robot, one LiDAR device is for monitoring an area to the left of the robot, and the other one is for monitoring an area to the right of the robot, but the present disclosure is not limited thereto.

Also, a LiDAR device according to an embodiment may be installed in a robot. For example, when the LiDAR device is installed in a robot, the LiDAR device is for recognizing a human face, but the present disclosure is not limited thereto.

Also, a LiDAR device according to an embodiment may be installed for industrial security. For example, the LiDAR device may be installed in a smart factory for the purpose of industrial security.

Also, a plurality of LiDAR devices according to an embodiment may be installed in a smart factory for the purpose of industrial security. For example, when two LiDAR devices are installed in a smart factory, one LiDAR device is for monitoring an area in front of the smart factory, and the other one is for monitoring an area behind the smart factory, but the present disclosure is not limited thereto. Also, for example, when two LiDAR devices are installed in a smart factory, one LiDAR device is for monitoring an area to the left of the smart factory, and the other one is for monitoring an area to the right of the smart factory, but the present disclosure is not limited thereto.

Also, a LiDAR device according to an embodiment may be installed for industrial security. For example, when the LiDAR device is installed for industrial security, the LiDAR device is for recognizing a human face, but the present disclosure is not limited thereto.

Various embodiments of elements of the LiDAR device will be described in detail below.

1.1. A Structure of LiDAR Device According to an Embodiment

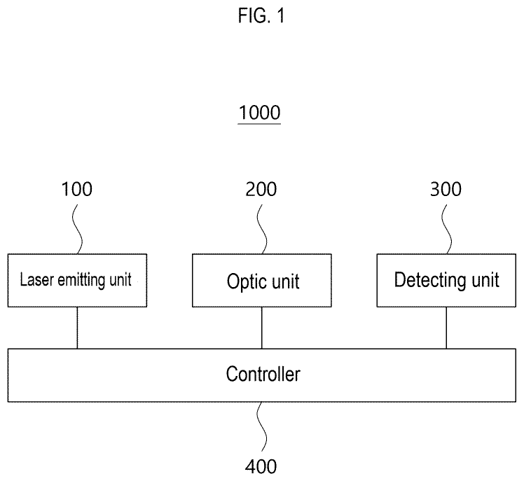

FIG. 1 is a diagram illustrating a LiDAR device according to an embodiment.

Referring to FIG. 1, a LiDAR device 1000 according to an embodiment may include a laser emitting unit 100.

In this case, the laser emitting unit 100 according to an embodiment may emit a laser beam.

Also, the laser emitting unit 100 may include one or more laser emitting elements. For example, the laser emitting unit 100 may include a single laser emitting element and may include a plurality of laser emitting elements. Also, when the laser emitting unit 100 includes a plurality of laser emitting elements, the plurality of laser emitting elements may constitute one array.

Also, the laser emitting unit 100 may include a laser diode (LD), a solid-state laser, a high power laser, a light-emitting diode (LED), a vertical-cavity surface-emitting laser (VCSEL), an external cavity diode laser (ECDL), and the like, but the present disclosure is not limited thereto.

Also, the laser emitting unit 100 may output a laser beam of a certain wavelength. For example, the laser emitting unit 100 may output a laser beam with a wavelength of 905 nm or a laser beam with a wavelength of 1550 nm. Also, for example, the laser emitting unit 100 may output a laser beam with a wavelength of 940 nm. Also, for example, the laser emitting unit 100 may output a laser beam with a plurality of wavelengths ranging between 800 nm and 1000 nm. Also, when the laser emitting unit 100 includes a plurality of laser emitting elements, some of the plurality of laser emitting elements may output a laser beam with a wavelength of 905 nm, and the others may output a laser beam with a wavelength of 1500 nm.

Referring to FIG. 1 again, the LiDAR device 1000 according to an embodiment may include an optic unit 200.

Herein, the optic unit may be variously expressed as a steering unit, a scanning unit, etc., but the present disclosure is not limited thereto.

In this case, the optic unit 200 according to an embodiment may change a flight path of a laser beam. For example, the optic unit 200 may change a flight path of a laser beam such that a laser beam emitted from the laser emitting unit 100 is directed to a scanning region. Also, for example, the optic unit 200 may change a flight path of laser beam such that a laser beam reflected by an object located in the scanning region is directed to a detecting unit.

Also, the optic unit 200 according to an embodiment may change a flight path of laser beam by reflecting a laser beam. For example, the optic unit 200 may change flight path of a laser beam by reflecting a laser beam emitted from the laser emitting unit 100 such that the laser beam is directed to the scanning region. Also, for example, the optic unit 200 may change a flight path of laser beam such that a laser beam reflected by an object located in the scanning region is directed to the detecting unit.

Also, the optic unit 200 according to an embodiment may include various optic means to reflect laser beams. For example, the optic unit 200 may include a mirror, a resonance scanner, a micro-electromechanical system (MEMS) mirror, a voice coil motor (VCM), a polygonal mirror, a rotating mirror, or a galvano mirror, and the like, but the present disclosure is not limited thereto.

Also, the optic unit 200 according to an embodiment may change a flight path of laser beam by refracting laser beams. For example, the optic unit 200 may change a flight path of laser beam by refracting a laser beam emitted from the laser emitting unit 100 such that the laser beam is directed to the scanning region. Also, for example, the optic unit 200 may change a flight path of laser beam such that a laser beam reflected by an object located in the scanning region is directed to the detecting unit.

Also, the optic unit 200 according to an embodiment may include various optic means to refract laser beams. For example, the optic unit 200 may include lenses, prisms, microlenses, or microfluidic lenses, but the present disclosure is not limited thereto.

Also, the optic unit 200 according to an embodiment may change a flight path of laser beam by changing the phase of a laser beam. For example, the optic unit 200 may change a flight path of laser beam by changing the phase of a laser beam emitted from the laser emitting unit 100 such that the laser beam is directed to the scanning region. Also, for example, the optic unit 200 may change a flight path of laser beam such that a laser beam reflected by an object located in the scanning region is directed to the detecting unit.

Also, the optic unit 200 according to an embodiment may include various optic means to change the phase of a laser beam. For example, the optic unit 200 may include an optical phased array (OPA), a metalens, a metasurface, or the like, but the present disclosure is not limited thereto.

Also, the optic unit 200 according to an embodiment may include one or more optic means. Also, for example, the optic unit 200 may include a plurality of optic means.

Referring to FIG. 1 again, the LiDAR device 1000 according to an embodiment may include a detecting unit 300.

Herein, the detecting unit may be variously expressed as a light receiving unit, a sensor unit, etc., but the present disclosure is not limited thereto.

In this case, the detecting unit 300 according to an embodiment may detect laser beams. For example, the detecting unit may detect a laser beam reflected by an object located in the scanning region.

Also, the detecting unit 300 according to an embodiment may receive a laser beam and generate an electric signal based on the received laser beam. For example, the detecting unit 300 may detect a laser beam reflected by an object located in the scanning region and generate an electric signal based on the received laser beam. Also, for example, the detecting unit 300 may receive a laser beam reflected by an object located in the scanning region through one or more optical means and generate an electric signal based on the received laser beam. Also, for example, the detecting unit 300 may receive a laser beam reflected by an object located in the scanning region through an optical filter and generate an electric signal based on the received laser beam.

Also, the detecting unit 300 according to an embodiment may detect the laser beam based on the generated electric signal. For example, the detecting unit 300 may detect the laser beam by comparing the magnitude of the generated electric signal to a predetermined threshold, but the present disclosure is not limited thereto. Also, for example, the detecting unit 300 may detect the laser beam by comparing the rising edge, falling edge, or the median of the rising edge and the falling edge of the generated electric signal to a predetermined threshold, but the present disclosure is not limited thereto. Also, for example, the detecting unit 300 may detect the laser beam by comparing the peak value of the generated electric signal to a predetermined threshold, but the present disclosure is not limited thereto.

Also, the detecting unit 300 according to an embodiment may include various detecting elements. For example, the detecting unit 300 may include a PN photodiode, a phototransistor, a PIN photodiode, an avalanche photodiode (APD), a single-photon avalanche diode (SPAD), silicon photomultipliers (SiPM), a time-to-digital converter (TDC), a comparator, a complementary metal-oxide-semiconductor (CMOS), a charge-coupled device (CCD), or the like, but the present disclosure is not limited thereto.

For example, the detecting unit 300 may be a two-dimensional (2D) SPAD array, but the present disclosure is not limited thereto. Also, for example, the SPAD array may include a plurality of SPAD units, and each SPAD unit may include a plurality of SPAD pixels.

In this case, the detecting unit 300 may generate a histogram by accumulating a plurality of data sets based on output signals of the detecting elements N times using the 2D SPAD array. For example, the detecting unit 300 may use the histogram to detect a reception time point of a laser beam that is reflected by an object and received.

For example, the detecting unit 300 may use the histogram to determine the peak time point of the histogram as the reception time point at which the laser beam reflected by the object is received, but the present disclosure is not limited thereto. Also, for example, the detecting unit 300 may use the histogram to determine a time point at which the histogram is greater than or equal to a predetermined value as the reception time point at which the laser beam reflected by the object is received, but the present disclosure is not limited thereto.

Also, the detecting unit 300 according to an embodiment may include one or more detecting elements. For example, the detecting unit 300 may include a single detecting element and may also include a plurality of detecting elements.

Also, the detecting unit 300 according to an embodiment may include one or more optical elements. For example, the detecting unit 300 may include an aperture, a microlens, a converging lens, a diffuser, or the like, but the present disclosure is not limited thereto.

Also, the detecting unit 300 according to an embodiment may include one or more optical filters. The detecting unit 300 may detect a laser beam reflected by an object through an optical filter. For example, the detecting unit 300 may include a band-pass filter, a dichroic filter, a guided-mode resonance filter, a polarizer, a wedge filter, or the like, but the present disclosure is not limited thereto.

Referring to FIG. 1 again, the LiDAR device 1000 according to an embodiment may include a processor 400.

Herein, the processor may be variously expressed as a processor or the like, but the present disclosure is not limited thereto.

In this case, the processor 400 according to an embodiment may control the operation of the laser emitting unit 100, the optic unit 200, or the detecting unit 300.

Also, the processor 400 according to an embodiment may control the operation of the laser emitting unit 100.

For example, the processor 400 may control an emission time point of a laser emitting from the laser emitting unit 100. Also, the processor 400 may control the power of the laser emitting from the laser emitting unit 100. Also, the processor 400 may control the pulse width of the laser emitting from the laser emitting unit 100. Also, the processor 400 may control the cycle of the laser emitting from the laser emitting unit 100. Also, when the laser emitting unit 100 includes a plurality of laser emitting elements, the processor 400 may control the laser emitting unit 100 to operate some of the plurality of laser emitting elements.

Also, the processor 400 according to an embodiment may control the operation of the optic unit 200.

For example, the processor 400 may control the operating speed of the optic unit 200. In detail, the optic unit 200 may control the rotational speed of a rotating mirror when including the rotating mirror and may control the repetition cycle of a MEMS mirror when including the MEMS mirror, but the present disclosure is not limited thereto.

Also, for example, the processor 400 may control the operation status of the optic unit 200. In detail, the optic unit 200 may control the operation angle of a MEMS mirror when including the MEMS mirror, but the present disclosure is not limited thereto.

Also, the processor 400 according to an embodiment may control the operation of the detecting unit 300.

For example, the processor 400 may control the sensitivity of the detecting unit 300. In detail, the processor 400 may control the sensitivity of the detecting unit 300 by adjusting a predetermined threshold, but the present disclosure is not limited thereto.

Also, for example, the processor 400 may control the operation of the detecting unit 300. In detail, the processor 400 may control the turn-on and -off of the detecting unit 300, and when including a plurality of detecting elements, the processor 400 may control the operation of the detecting unit 300 to operate some of the plurality of detecting elements.

Also, the processor 400 according to an embodiment may determine a distance from the LiDAR device 1000 to an object located in a scanning region based on a laser beam detected by the detecting unit 300.

For example, the processor 400 may determine the distance to the object located in the scanning region based on a time point at which the laser beam is emitted from the laser emitting unit 100 and a time point at which the laser beam is detected by the detecting unit 300. Also, for example, the processor 400 may determine the distance to the object located in the scanning region based on a time point at which a laser beam emitted from the laser beam is detected by the detecting unit 300 immediately without reaching the object and a time point at which a laser beam reflected by the object is sensed by the detecting unit 300.

There may be a difference between a time point at which the LiDAR device 1000 transmits a trigger signal for emitting a laser beam using a processor 400 and an actual emission time point, which is a time when the laser beam is actually emitted from a laser emitting element. Actually, no laser beam is emitted in a period between the time point of the trigger signal and the actual emission time point. Thus, when the period is included in the ToF of the laser beam, precision may be decreased.

The actual emission time point of the laser beam may be used to improve the precision of the measurement of the TOF of the laser beam. However, it may be difficult to determine the actual emission time point of the laser beam. Therefore, a laser beam should be detected to the detecting unit 300 as soon as or immediately after the laser beam is emitted from a laser emitting element without reaching an object.

For example, an optic may be disposed on an upper portion of the laser emitting element, and thus the optic may enable a laser beam emitted from the laser emitting element to be detected by the detecting unit 300 directly without reaching an object. The optic may be a mirror, a lens, a prism, a metasurface, or the like, but the present disclosure is not limited thereto. The optic may include one optic or a plurality of optics.

Also, for example, the detecting unit 300 may be disposed on an upper portion of the laser emitting element, and thus a laser beam emitted from the laser emitting element may be detected by the detecting unit 300 directly without reaching an object. The detecting unit 300 may be spaced a distance of 1 mm, 1 μm, 1 nm, or the like from the laser emitting element, but the present disclosure is not limited thereto. Alternatively, the detecting unit 300 may be adjacent to the laser emitting element with no interval therebetween. An optic may be present between the detecting unit 300 and the laser emitting element, but the present disclosure is not limited thereto.

In detail, the laser emitting unit 100 may emit a laser beam, and the processor 400 may acquire a time point at which the laser beam is emitted from the laser emitting unit 100. When the laser beam emitted from the laser emitting unit 100 is reflected by an object located in the scanning region, the detecting unit 300 may detect a laser beam reflected by the object, and the processor 400 may acquire a time point at which the laser beam is detected by the detecting unit 300 and may determine a distance to the object located in the scan region based on the emission time point and the detection time point of the laser beam.

Also, in detail, the laser beam may be emitted from the laser emitting unit 100, and the laser beam emitted from the laser emitting unit 100 may be detected by the detecting unit 300 directly without reaching the object located in the scanning region. In this case, the processor 400 may acquire a time point at which the laser beam is detected without reaching the object. When the laser beam emitted from the laser emitting unit 100 is reflected by the object located in the scanning region, the detecting unit 300 may detect the laser beam reflected by the object, and the processor 400 may acquire the time point at which the laser beam is detected by the detecting unit 300. In this case, the processor 400 may determine the distance to the object located in the scanning region based on the detection time point of the laser beam that does not reach the object and the detection time point of the laser beam that is reflected by the object.

Hereinafter, a detailed configuration of a detecting unit of a LiDAR device and a signal processing method according to an embodiment will be described in detail.

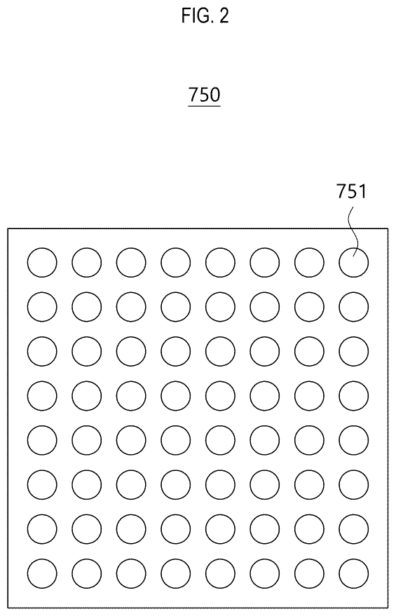

FIG. 2 is a diagram for illustrating a SPAD array according to one embodiment.

Referring to FIG. 2, the detecting unit 300 according to one embodiment may include a SPAD array 750. FIG. 2 illustrates a SPAD array in an 8×8 matrix, but the present disclosure is not limited thereto, and the SPAD array in a 10×10 matrix, a 12×12 matrix, a 24×24 matrix, a 64×64 matrix, and the like may be used.

The SPAD array 750 according to one embodiment may include a plurality of SPADs 751. For example, the plurality of SPADs 751 may be disposed in a matrix structure, but is not limited thereto, and may be disposed in a circular structure, an elliptical structure, a honeycomb structure, or the like.

When a laser beam is incident on the SPAD array 750, photons may be detected due to an avalanche phenomenon. According to one embodiment, results from the SPAD array 750 may be accumulated in the form of a histogram.

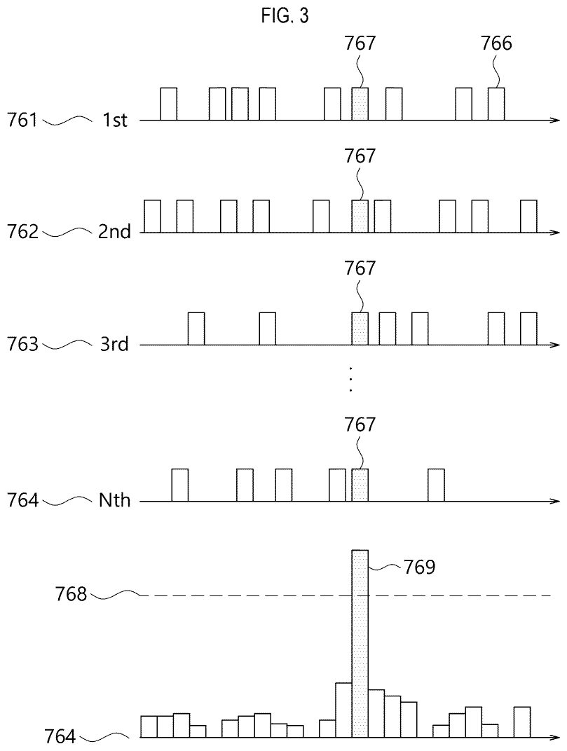

FIG. 3 is a diagram for illustrating a histogram for a SPAD according to an embodiment.

Referring to FIG. 3, the SPAD 751 according to one embodiment may detect photons. When the SPAD 751 detects photons, signals 766 and 767 may be generated.

A recovery time may be required for the SPAD 751 to return to a state capable of detecting photons again after detecting photons. When the SPAD 751 detects photons and the recovery time has not elapsed, even when photons are incident on the SPAD 751 at this time, the SPAD 751 is unable to detect the photons. Accordingly, a resolution of the SPAD 751 may be determined by the recovery time.

According to one embodiment, the SPAD 751 may detect photons for a predetermined period of time after a laser beam is emitted from a laser emitting unit. At this point, the SPAD 751 may detect photons for a cycle of predetermined time. For example, the SPAD 751 may detect photons several times according to a time resolution of the SPAD 751 during the cycle. At this point, the time resolution of the SPAD 751 may be determined by the recovery time of the SPAD 751.

According to one embodiment, the SPAD 751 may detect photons reflected from an object and other photons. For example, the SPAD 751 may generate the signal 767 when detecting the photons reflected from the object.

Further, for example, the SPAD 751 may generate the signal 766 when detecting photons other than the photons reflected from the object. In this case, the photons other than the photons reflected from the object may be sunlight, a laser beam reflected from a window, and the like.

According to one embodiment, the SPAD 751 may detect photons for a cycle of predetermined time after the laser beam is emitted from the laser emitting unit.

For example, the SPAD 751 may detect photons for a first cycle after a first laser beam is emitted from the laser emitting unit. At this point, the SPAD 751 may generate a first detection signal 761 after detecting the photons.

Further, for example, the SPAD 751 may detect photons for a second cycle after a second laser beam is emitted from the laser emitting unit. At this point, the SPAD 751 may generate a second detection signal 762 after detecting the photons.

Further, for example, the SPAD 751 may detect photons for a third cycle after a third laser beam is emitted from the laser emitting unit. At this point, the SPAD 751 may generate a third detection signal 763 after detecting the photons.

Further, for example, the SPAD 751 may detect photons for an Nth cycle after an Nth laser beam is emitted from the laser emitting unit. At this point, the SPAD 751 may generate an Nth detection signal 764 after detecting the photons.

Here, each of the first detection signal 761, the second detection signal 762, the third detection signal 763, . . . , and the Nth detection signal 764 may include the signal 767 generated by detecting photons reflected from the object or the signal 766 generated by detecting photons other than the photon reflected by the object.

In this case, the Nth detection signal 764 may be a photon detection signal generated for the Nth cycle after the Nth laser beam is emitted. For example, N may be 5, 10, 20, 30, 40, 50, 60, 70, 80, 90, 100, 200, 300, or the like.

The signals generated by the SPAD 751 may be accumulated in the form of a histogram. The histogram may have a plurality of histogram bins. The signals generated by the SPAD 751 may be accumulated in the form of a histogram to respectively correspond to the histogram bins.

For example, the histogram may be formed by accumulating signals generated by one SPAD 751, or may be formed by accumulating signals generated by the plurality of SPADs 751.

For example, a histogram 765 may be formed by accumulating the first detection signal 761, the second detection signal 762, the third detection signal 763, . . . , and the Nth detection signal 764. In this case, the histogram 765 may include a signal generated due to photons reflected from the object or a signal generated due to the other photons.

In order to obtain distance information of the object, it is necessary to extract a signal generated due to photons reflected from the object from the histogram 765. The signal generated due to the photons reflected from the object may be greater in amount and more regular than the signal generated due to the other photons.

At this point, the signal generated due to the photons reflected from the object may be regularly present at a specific time within the cycle. On the other hand, the signal generated due to sunlight may be small in amount and irregularly present.

There is a high possibility that a signal having a large accumulation amount of the histogram at a specific time is a signal generated due to photons reflected from the object. Accordingly, of the accumulated histogram 765, a signal having a large accumulation amount may be extracted as a signal generated due to photons reflected from the object.

For example, of the histogram 765, a signal having the highest value may be simply extracted as a signal generated due to photons reflected from the object. Further, for example, of the histogram 765, a signal having a value greater than or equal to a predetermined amount 768 may be extracted as a signal generated due to photons reflected from the object.

In addition to the method described above, there may be various algorithms that may extract as a signal, which is generated due to photons reflected from the object, from the histogram 765.

The signal generated due to photons reflected from the object is extracted from the histogram 765, and then, based on a generation time of the corresponding signal, a reception time of the photons, or the like, the distance information of the object may be calculated.

For example, the signal extracted from the histogram 765 may be a signal at one scan point. At this point, one scan point may correspond to one SPAD.

For another example, the signals extracted from the plurality of histograms may be signals at one scan point. At this point, one scan point may correspond to the plurality of SPADs.

According to another embodiment, the signals extracted from the plurality of histograms may be calculated as a signal at one scan point by applying weights thereto. At this point, the weights may be determined by a distance between the SPADs.

For example, a signal at a first scan point may be calculated by applying a weight of 0.8 to a signal by a first SPAD, applying a weight of 0.6 to a signal by a second SPAD, applying a weight of 0.4 to a signal by a third SPAD, and applying a weight of 0.2 to a signal by a fourth SPAD.

When the signals extracted from the plurality of histograms are calculated as a signal at one scan point by applying weights thereto, it is possible to obtain an effect of accumulating the histogram multiple times with one accumulation of the histogram. Thus, a scan time may be reduced, and an effect of reducing the time to obtain the entire image may be derived.

According to still another embodiment, the laser emitting unit may emit a laser beam to be addressable. Alternatively, the laser emitting unit may emit a laser beam to be addressable for each VCSEL unit.

For example, the laser emitting unit may emit a laser beam from a VCSEL unit in a first row and first column one time, and then emit a laser beam from a VCSEL unit in a first row and third column one time, and then emit a laser beam from a VCSEL unit in a second row and fourth column one time. As described above, the laser emitting unit may emit a laser beam from a VCSEL unit in an Ath row and Bth column N times, and then emit a laser beam from a VCSEL unit of a Cth row and Dth column M times.

At this point, the SPAD array may receive, among the laser beam emitted from the corresponding VCSEL unit, the laser beam reflected from the object.

For example, when the VCSEL unit in the first row and first column emits the laser beam N times in a sequence of emitting the laser beam by the laser emitting unit, a SPAD unit in a first row and first column corresponding to the first row and first column may receive the laser beam reflected from the object up to N times.

Further, for example, when the reflected laser beam should be accumulated N times in the histogram of the SPAD, and there are M VCSEL units in the laser emitting unit, it is possible to operate the M VCSEL units N times at once. Alternatively, it is possible to operate M VCSEL units one by one M*N times, and it is also possible to operate M VCSEL units for every five VCSEL units M*N/5 times.

1.2. Structure of LiDAR Device According to an Another Embodiment

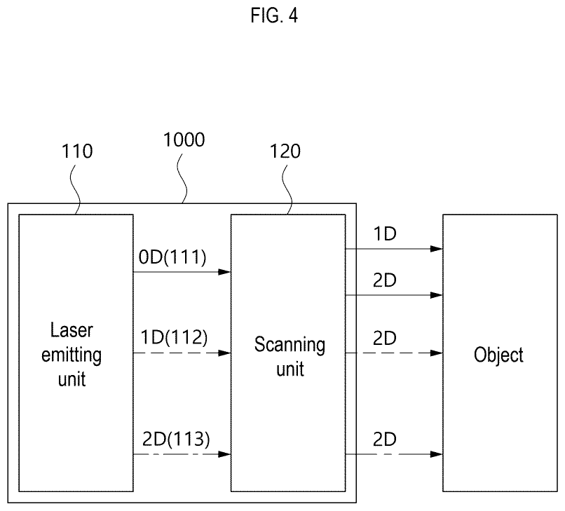

FIG. 4 is a diagram for illustrating functions of the LiDAR device including a scanner according to an embodiment.

Referring to FIG. 4, a function of the scanner 120 may vary according to an irradiation field of laser light output from the laser light emitting unit 110.

According to an embodiment, when the laser light emitting unit 110 has a single laser light output element, an irradiation field of laser light 111 output from the laser light emitting unit may be in the form of a point. In this case, the scanner 120 may change an irradiation direction and size of the laser light 111. Accordingly, a scan field of the lidar device may be expanded in the form of a line or a plane.

In addition, the scanner 120 may continuously change a traveling direction of the laser light 111 whose irradiation field is in the form of a point to change the irradiation direction of the laser light. Accordingly, the scan field of the lidar device may be expanded in the form of a plane.

In addition, the scanner 120 may diffuse the laser light 111 whose irradiation field is in the form of a point to change the size of the laser light. Accordingly, the scan field of the lidar device may be expanded in the form of a line or a plane.

In addition, the scanner 120 may change a phase of the laser light 111 whose irradiation field is in the form of a point to change the size and irradiation direction of the laser light. Accordingly, the scan field of the lidar device may be expanded in the form of a line or a plane.

In addition, the scanner 120 may, first, continuously change a traveling direction of the laser light 111 whose irradiation field is in the form of a point and then, second, change the traveling direction of the laser light to a direction different from the previous traveling direction to change an irradiation direction of the laser light. Accordingly, the scan field of the lidar device 100 may be expanded in the form of a plane.

In addition, the scanner 120 may, first, continuously change a traveling direction of the laser light 111 whose irradiation field is in the form of a point and then, second, diffuse the laser light to change the irradiation direction and size of the laser light. Accordingly, the scan field of the lidar device may be expanded in the form of a plane.

In addition, the scanner 120 may, first, diffuse the laser light 111 whose irradiation field is in the form of a point and then, second, continuously change a traveling direction of the diffused laser light to change the irradiation direction and size of the laser light. Accordingly, the scan field of the lidar device may be expanded in the form of a plane.

According to another embodiment, when the laser light emitting unit 110 is formed of a plurality of laser light output elements, an irradiation field of laser light 112 output from the laser light emitting unit may be in the form of a line. Here, the scanner 120 may change an irradiation direction and a size of the laser light 112. Accordingly, a scan field of the lidar device may be expanded in the form of a plane.

In this case, the scanner 120 may continuously change a traveling direction of the laser light 112 whose irradiation field is in the form of a line to change an irradiation direction of the laser light. Accordingly, the scan field of the lidar device may be expanded in the form of a plane.

In addition, the scanner 120 may diffuse the laser light 112 whose irradiation field is in the form of a line to change the size of the laser light. Accordingly, the scan field of the lidar device may be expanded in the form of a plane.

In addition, the scanner 120 may change a phase of the laser light 112 whose irradiation field is in the form of a line to change the irradiation direction and size of the laser light. Accordingly, the scan field of the lidar device may be expanded in the form of a plane.

According to another embodiment, when the laser light emitting unit 110 includes an array of laser light output elements arranged in a row, the irradiation field of the laser light 112 output from the laser light emitting unit 110 may be in the form of a line. Here, the scanner 120 may change the irradiation direction and size of the laser light 112. Accordingly, the scan field of the lidar device may be expanded in the form of a plane.

In this case, the scanner 120 may continuously change a traveling direction of the laser light 112 whose irradiation field is in the form of a line to change the irradiation direction of the laser light. Accordingly, the scan field of the lidar device may be expanded in the form of a plane.

In addition, the scanner 120 may diffuse the laser light 112 whose irradiation field is in the form of a line to change the size of the laser light. Accordingly, the scan field of the lidar device may be expanded in the form of a plane.

In addition, the scanner 120 may change a phase of the laser light 112 whose irradiation field is in the form of a line to change the irradiation direction and size of the laser light. Accordingly, the scan field of the lidar device may be expanded in the form of a plane.

According to another embodiment, when the laser light emitting unit 110 is formed of a plurality of laser light output elements, an irradiation field of laser light 113 output from the laser light emitting unit 110 may be in the form of a plane. Here, the scanner 120 may change an irradiation direction and a size of the laser light. Accordingly, a scan field of the lidar device may be expanded or a scanning direction may be changed.

In this case, the scanner 120 may continuously change a traveling direction of the laser light 113 whose irradiation field is in the form of a plane to change an irradiation direction of the laser light. Accordingly, the scan field of the lidar device may be expanded or the scanning direction may be changed.

In addition, the scanner 120 may diffuse the laser light 113 whose irradiation field is in the form of a plane to change the size of the laser light. Accordingly, the scan field of the lidar device may be expanded or the scanning direction may be changed.

In addition, the scanner 120 may change a phase of the laser light 113 whose irradiation field is in the form of a plane to change the irradiation direction and size of the laser light. Accordingly, the scan field of the lidar device may be expanded or the scanning direction may be changed.

According to another embodiment, when the laser light emitting unit 110 includes laser light output elements forming a planar array, the irradiation field of the laser light 113 output from the laser light emitting unit 110 may be in the form of a plane. Here, the scanner 120 may change the irradiation direction and size of the laser light. Accordingly, the scan field of the lidar device may be expanded or the scanning direction may be changed.

In this case, the scanner 120 may continuously change a traveling direction of the laser light 113 whose irradiation field is in the form of a plane to change the irradiation direction of the laser light. Accordingly, the scan field of the lidar device may be expanded or the scanning direction may be changed.

In addition, the scanner 120 may diffuse the laser light 113 whose irradiation field is in the form of a plane to change the size of the laser light. Accordingly, the scan field of the lidar device may be expanded or the scanning direction may be changed.

In addition, the scanner 120 may change a phase of the laser light 113 whose irradiation field is in the form of a plane to change the irradiation direction and size of the laser light. Accordingly, the scan field of the lidar device may be expanded or the scanning direction may be changed.

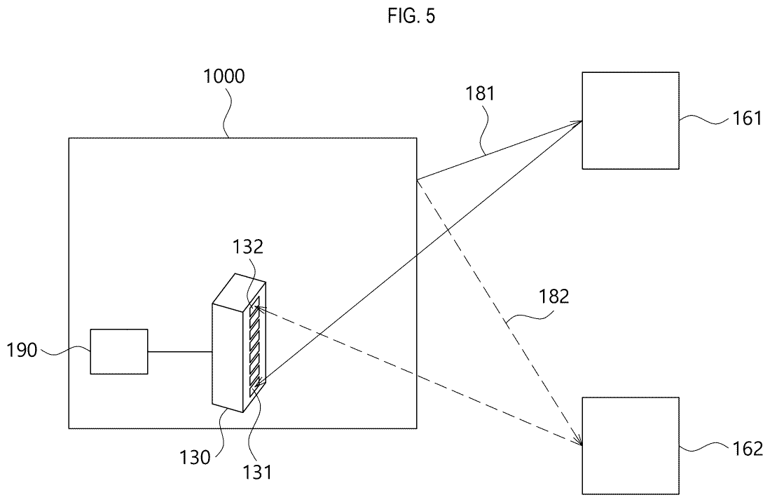

FIG. 5 is a diagram illustrating a LiDAR device including a detecting unit according to an embodiment.

Referring to FIG. 5, a LiDAR device 1000 according to an embodiment may include a detecting unit 130, and the detecting unit 130 may include a plurality of detecting elements 131 and 132. For example, the detecting unit 130 may include an APD array including a plurality of APD detectors, but is not limited thereto. In addition, the LiDAR device 1000 may include a controller 190 for controlling the detecting unit. The LiDAR device 1000 may emit lasers 181 and 182 to the scan area to detect objects 161 and 162 located in the scan area.

Specifically, the LiDAR device 1000 may emit a first laser 181 in a first emission direction, and may receive the first laser 181 reflected by the first object 161 through the detecting unit 130.

In addition, the LiDAR device 1000 may emit a second laser 182 in a second emission direction, and may receive the second laser 182 reflected by the second object 162 through the detecting unit 130.

Herein, the first laser 181 and the second laser 182 may be emitted simultaneously, or may be emitted at different times.

Herein, the first laser 181 and the second laser 182 may be emitted through the same laser emitter, or may be emitted from different laser emitters.

Herein, the first laser 181 and the second laser 182 may be lasers of the same wavelength band, or may be lasers of different wavelength bands.

Herein, the first emission direction and the second emission direction may be different from each other.

In addition, when the first emission direction and the second emission direction are different from each other, the angles at which the first and the second laser 181 and 182 reflect off the first and the second object 161 and 162 and incident on the LiDAR device 1000 are different from each other, so the locations at which the lasers are received by the detecting unit 130 may vary.

Herein, when the first laser 181 is reflected by the first object 161 and is received by the detecting unit 130, the first laser 181 may be received by a first detecting element 131 of the detecting unit 130.

Herein, when the second laser 182 is reflected by the second object 162 and is received by the detecting unit 130, the second laser 182 may be received by a second detecting element 132 of the detecting unit 130.

Accordingly, when the first emission direction and the second emission direction are different from each other, the placement locations of the first detecting element 131 and the second detecting element 132 may be different from each other.

More specifically, the first emission direction and the second emission direction may be different from each other such that the emission location of the first laser 181 and the emission location of the second laser 182 at a predetermined distance from the LiDAR device 1000 are different from each other.

Herein, when the emission location of the first laser 181 and the emission location of the second laser 182 at a predetermined distance from the LiDAR device 1000 are represented in any rectangular coordinate system including a first axis and a second axis, a first axis value of the emission location of the first laser 181 and a first axis value of the emission location of the second laser 182 may be different from each other.

Herein, when the placement location of the first detecting element 131 and the placement location of the second detecting element 132 are represented in any rectangular coordinate system including the first axis and the second axis, a first axis value of the placement location of the first detecting element 131 and a first axis value of the placement location of the second detecting element 132 may be different from each other.

In addition, when the first axis value of the emission location of the first laser 181 is greater than the first axis value of the emission location of the second laser 182, the first axis value of the placement location of the first detecting element 131 may be less than the first axis value of the placement location of the second detecting element 132.

For example, when a vertical axis value of the emission location of the first laser 181 is greater than a vertical axis value of the emission location of the second laser 182, the emission location of the first laser 181 is above the emission location of the second laser 182 and a vertical axis value of the placement location of the first detecting element 131 may be less than a vertical axis value of the placement location of the second detecting element 132, so the first detecting element 131 may be positioned lower than the second detecting element 132.

In addition, the controller 190 may control the detecting elements 131 and 132 of the detecting unit 130.

Specifically, the controller 190 may control the detecting elements 131 and 132 of the detecting unit 130 on the basis of emission directions of lasers emitted from the LiDAR device 1000.

For example, when the first laser 181 emitted in the first emission direction is emitted from the LiDAR device 1000, the first laser 181 is reflected by the first object 161 and is received by the first detecting element 131, so the controller 190 may operate the first detecting element 131.

In addition, when the second laser 182 emitted in the second emission direction is emitted from the LiDAR device 1000, the second laser 182 is reflected by the second object 162 and is received by the second detecting element 132, so the controller 190 may operate the second detecting element 131.

Herein, the controller 190 may operate the first and the second detecting element 131 and 132 simultaneously, or may operate them at different times.

In addition, the controller 190 may turn off the second detecting element 132 while operating the first detecting element 131.

In addition, the controller 190 may turn off the first detecting element 131 while operating the second detecting element 132.

In addition, as described above, when the controller 190 controls the operation of the detecting unit 130 by turning off the second detecting element 132 while operating the first detecting element 131, or by turning off the first detecting element 131 while operating the second detecting element 132, noise received by the detecting unit 130 due to causes other than the lasers emitted from the LiDAR device 1000 and received by the detecting unit 130 may be effectively reduced.

In addition, when the controller 190 controls the operation of the detecting unit 130 on the basis of the emission directions of the lasers emitted from the LiDAR device 1000, the LiDAR device 1000 may simultaneously detect a plurality of lasers emitted from the LiDAR device 1000 in different directions.

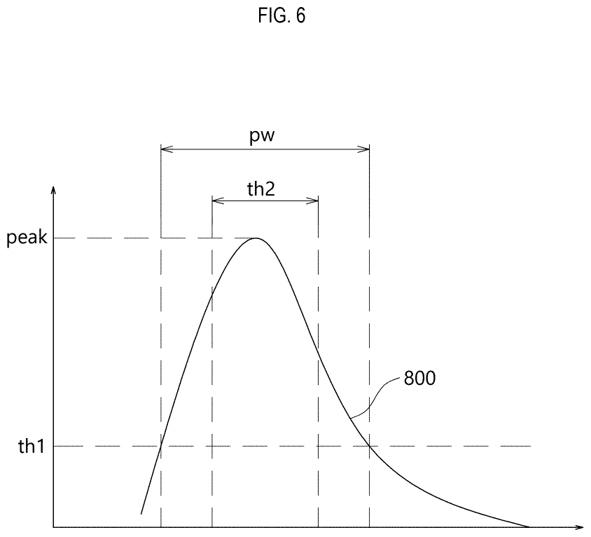

FIG. 6 is a diagram illustrating a method of obtaining information on the basis of a detection signal generated by a detecting unit according to an embodiment.

Referring to FIG. 6, a LiDAR device according to an embodiment may receive a laser, and may generate a detection signal 800 on the basis of the received laser. Herein, the detection signal 800 may be variously expressed as a detecting signal, a measurement signal, a detection pulse, or an electrical signal. More specifically, the LiDAR device may receive a laser through a detecting unit and may generate the detection signal. For example, the detecting unit may receive at least a portion of a laser scattered from a detection point within a scan area to generate an electrical signal. Herein, the detection point is a point at which a laser emitted from the LiDAR device is scattered, so it may mean at least a portion of an object present within the scan area.

In addition, the LiDAR device may generate various types of detection signals 800. For example, the detection signal may be expressed as the magnitude of the current flowing through the detecting unit over time. In this case, the detection signal may be an analog signal, which has continuous values, in the form of a pulse having an amplitude. In addition, without being limited thereto, the detection signal may be expressed as the number (counting value) of photons of the laser detected during a predetermined time period (time bin). In this case, the detection signal may be a digital signal, which has discontinuous values.

In addition, the LiDAR device may detect an object on the basis of a characteristic of the detection signal. Herein, the characteristic of the detection signal may include a pulse width (pw), an amplitude, a rising edge, a falling edge, a pulse area, or a peak of the detection signal, but is not limited thereto.

Specifically, the detecting unit may detect an object by determining whether the characteristic of the detection signal satisfies a predetermined condition.

For example, the LiDAR device may detect an object by using threshold values th1 and th2. Herein, the LiDAR device may preset a threshold value as a single value, but no limitation thereto is imposed. The LiDAR device may preset threshold values as a plurality of values.

More specifically, the LiDAR device may detect an object by determining whether the detection signal satisfies a predetermined condition based on the first threshold value th1. For example, the detecting unit may detect an object by comparing the first threshold value th1 with an amplitude of the generated detection signal. Herein, when the amplitude of the detection signal is greater than the first threshold value th1, the LiDAR device may determine that the detection signal is a signal corresponding to the object. In addition, for example, the detecting unit may detect an object by comparing the first threshold value th1 with a peak of the generated detection signal. In addition, for example, the detecting unit may detect an object by comparing the first threshold value th1 with an amplitude of a signal corresponding to the median of rising and falling edges, but no limitation thereto is imposed.

In addition, the LiDAR device may detect an object on the basis of a pulse width (pw) of the detection signal. Herein, the pulse width (pw) of the detection signal may be a width of a pulse when the amplitude of the detection signal is a predetermined amplitude. For example, the pulse width (pw) of the detection signal may be a distance between two intersections on the time axis of the detection signal when the amplitude of the detection signal is the first threshold value th1, but is not limited thereto.

In addition, the LiDAR device may detect an object by determining whether the pulse width (pw) of the detection signal satisfies a predetermined condition based on the second threshold value th2. Herein, the second threshold value th2 may correspond to the size of the minimum pulse width accompanying the detection of the object. That is, a detection signal generated on the basis of light that is scattered from an object and received may have a pulse width equal to or greater than the second threshold value th2. For example, when the pulse width (pw) of the detection signal is equal to or greater than the second threshold value (th2), an object may be detected on the basis of the detection signal having the pulse width (pw).

In addition, the LiDAR device may obtain various types of information on a detection point on the basis of a detection signal 800. More specifically, the LiDAR device may process the detection signal 800 to obtain distance information to the detection point and intensity information of the detection point, but no limitation thereto is imposed. A method of obtaining distance information to the detection point on the basis of the flight time of a laser has been described above, so the description thereof will be omitted.

The LiDAR device may obtain intensity information that represents the reflection intensity of the detection point on the basis of the detection signal 800. Herein, the intensity information may represent the amount (the number of photons) or intensity of laser light scattered from the detection point. In other words, the intensity information may be information that represents the degree of a laser scattered from the detection point.

Herein, the LiDAR device may obtain the intensity information of the detection point on the basis of a signal characteristic of the detection signal. For example, the LiDAR device may obtain the intensity information of the detection point on the basis of a pulse width (pw), a peak of the detection signal, a rising edge, a falling edge, or a pulse area of the detection point, but no limitation thereto is imposed.

As a specific example, the LiDAR device may obtain the intensity information of the detection point on the basis of the pulse width (pw) of the detection signal. Herein, the greater the amount of laser light reflected by the detection point, the greater the pulse width (pw) of the detection signal. That is, the size of the pulse width (pw) of the detection signal may be proportional to the intensity information of the detection point.

Accordingly, the LiDAR device may obtain an intensity value corresponding to the pulse width (pw). Herein, the intensity value may be a numerical representation of the intensity information. For example, the LiDAR device may set the size of the pulse width (pw) as the intensity value, but no limitation thereto is imposed. The LiDAR device may pre-store an intensity value proportional to the size of the pulse width (pw). Specifically, the LiDAR device may pre-store a matching table of a size of the pulse width (pw) and an intensity value, and may determine the intensity value corresponding to the size of the pulse width (pw) of the received detection signal on the basis of the matching table, thereby obtaining the intensity value of the detection point. In addition, it is to be understood that the words an intensity, intensity information, and an intensity value may be used interchangeably depending on the context.

Hereinafter, raw data obtainable through a LiDAR device, and property data resulting from processing the raw data will be described.

Hereinafter, a raw-data obtainable through a LiDAR device and a property data obtained by processing the raw-data will be describe.

2. Point Data Set

A LiDAR device according to an embodiment may generate a point data set by performing the above signal processing method based on light received from the outside. In this case, the point data set may refer to data including at least one piece of information about the external object based on an electrical signal generated by receiving at least a portion of light scattered from the external object. For example, the point data set may be a group of data including location information and intensity information of a plurality of detection points where light is scattered, but is not limited thereto.

2.1. A Configuration of Point Data Set

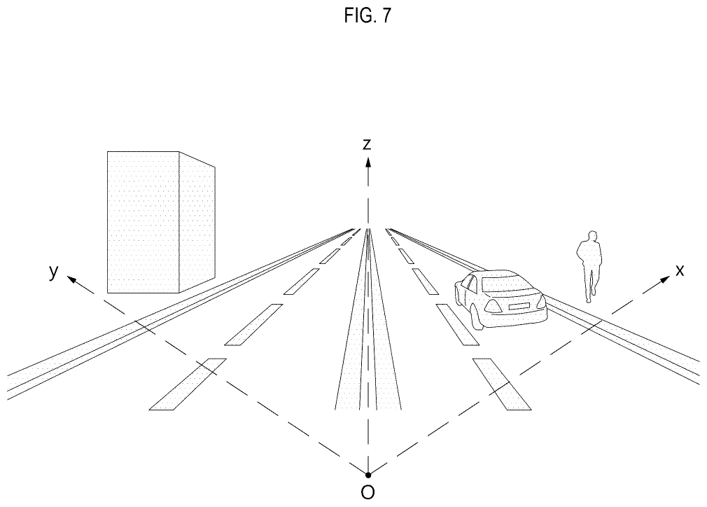

FIG. 7 is a diagram illustrating data displayed on a 3D map, the data being obtained by a LiDAR device.

Referring to FIG. 7, the controller of the LiDAR device may form a 3D point cloud image for a point data set based on a detection signal. Also, a location of the origin (O) of the 3D point cloud image may correspond to the optical origin of the LiDAR device, but is not limited thereto, and the location of the origin (O) of the 3D point cloud image may correspond to the center of gravity of the LiDAR device or the center of gravity of a vehicle in which the LiDAR device is placed.

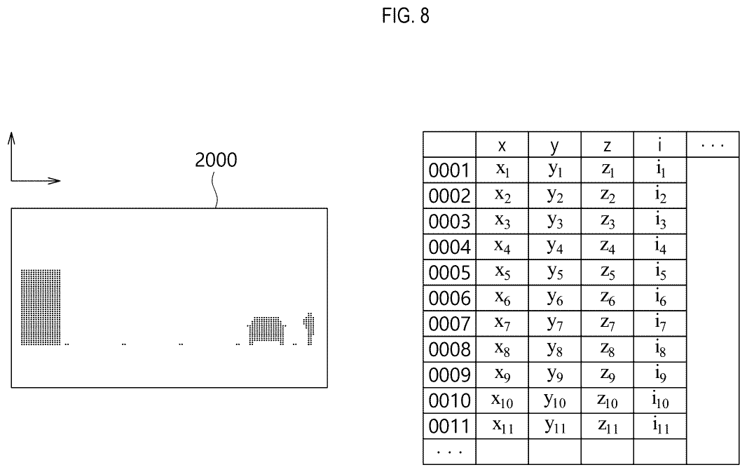

FIG. 8 is a diagram illustrating a point cloud simply displayed on a 2D plane.

Referring to FIG. 8, point cloud data 2000 may be expressed in a 2D plane.

Also, in the specification, the point cloud data may be expressed in the 2D plane, but this is for schematically representing data on a 3D map.

Also, the point cloud data 2000 may be expressed in the form of a data sheet. A plurality of pieces of information included in the point cloud data 2000 may be expressed as values in the data sheet.

Hereinafter, the point cloud data and the meanings of various forms of data included in the point cloud data will be described.

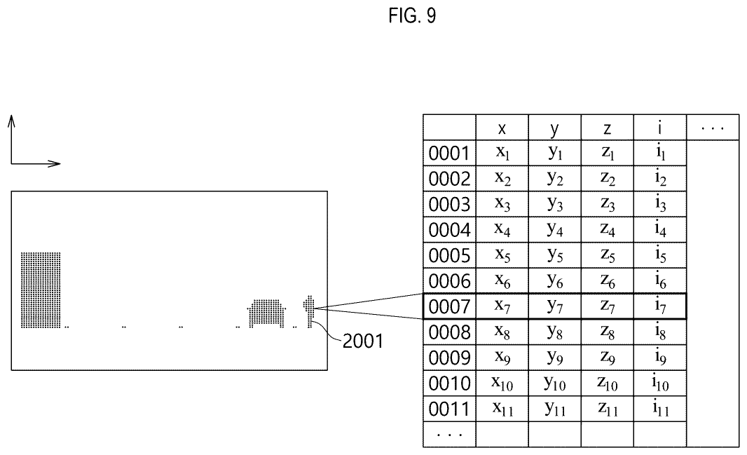

FIG. 9 is a diagram illustrating point data obtained from a LiDAR device according to an embodiment.

Referring to FIG. 9, the point cloud data 2000 may include point data 2001. At this time, the point data may represent data that can be obtained primarily as the lidar device detects the object. In addition, the point data may mean raw data (raw-data) that does not process the first information obtained from the lidar device.

In addition, the point data 2001 may be obtained as the LIDAR device scans at least a part of an object, and the point data 2001 may include location coordinates (x, y, z). Also, according to an embodiment, the point data 2001 may further include an intensity value (I).

In addition, the number of the point data 2001 may correspond to the number of lasers emitted from the lidar device scattered from an object and received by the lidar device.

More specifically, when the laser emitted from the lidar device is scattered on at least a part of the object and received by the lidar device, the lidar device receives a signal corresponding to the received laser whenever the laser is received. It is possible to generate the point data 2001 by processing.

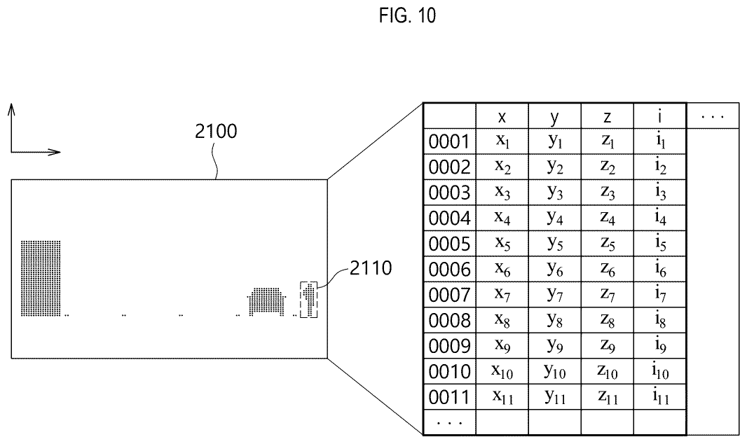

FIG. 10 is a diagram for illustrating a point data set obtained from a LiDAR device.

Referring to FIG. 10, point cloud data 2000 may be composed of a point data set 2100. In this case, the point data set 2100 may mean a data set of one frame constituting the point cloud data 2000, but is not limited thereto, and may collectively refer to a data set of a plurality of frames. Also, depending on the embodiment, the point data set 2100 and the point cloud data 2000 may be used as the same meaning.

In addition, the point data set 2100 may refer to a plurality of point data generated as the LIDAR device scans a scan area once. For example, when the horizontal FOV(Field of View) of the lidar device is 180 degrees, the point data set 2100 may mean all point data obtained by the lidar device scanning 180 degrees once.

In addition, the point data set 2100 may include position coordinates (x, y, z) and an intensity value (I) of an object included in the viewing angle of the LIDAR device. In addition, the location coordinates (x, y, z) and intensity value (I) of the point data 2001 included in the point data set 2100 may be expressed on a data sheet.

Also, the point data set 2100 may include noise data. The noise data may be generated by an external environment regardless of an object located within the FOV of the LIDAR device. For example, the noise data may include, but is not limited to, noise due to interference between lidars, noise due to ambient light such as sunlight, and noise caused by an object out of a measurable distance.

Also, the point data set 2100 may include background information. The background information may refer to at least one point data not related to an object among a plurality of point data included in the point data set 2100. In addition, the background information may be previously stored in an autonomous driving system including the LIDAR device. For example, the background information may include information on a static object such as a building (or a fixed object having a fixed location), and the background information may be stored in advance in the form of a map in the lidar device.

Referring back to FIG. 10, the point cloud data 2000 may include a sub point data set 2110. In this case, the sub point data set 2110 may mean a plurality of point data 2001 representing the same object. For example, when the point data set 2100 includes a plurality of point data representing a person (HUMAN), the plurality of point data may constitute one sub-point data set 2110.

Also, the sub point data set 2110 may be included in the point data set 2100. Also, the sub point data set 2110 may represent at least one object included in the point data set 2100 or at least a part of one object. More specifically, the sub point data set 2110 may mean a plurality of point data representing a first object among a plurality of point data included in the point data set 2100.

Also, the sub point data set 2110 may be obtained through clustering of at least one point data related to a dynamic object among a plurality of point data included in the point data set 2100. More specifically, after detecting static objects and dynamic objects (or moving objects) included in the point data set 2100 by utilizing the background information, by grouping data related to one object into a certain cluster, the sub point data set 2110 may be acquired.

Also, the sub point data set 2110 may be generated using machine learning. For example, the control unit of the lidar device may determine that at least some of a plurality of data included in the point cloud data 2000 represent the same object, based on machine learning trained for various objects.

Also, the sub point data set 2110 may be generated by segmenting the point data set 2100. At this time, the control unit of the lidar device may divide the point data set 2100 into predetermined segments. In addition, at least one segment unit of the divided point data set may represent at least a part of the first object included in the point data set 2100. Also, a plurality of segment units representing the first object may correspond to the sub point data set 2110.

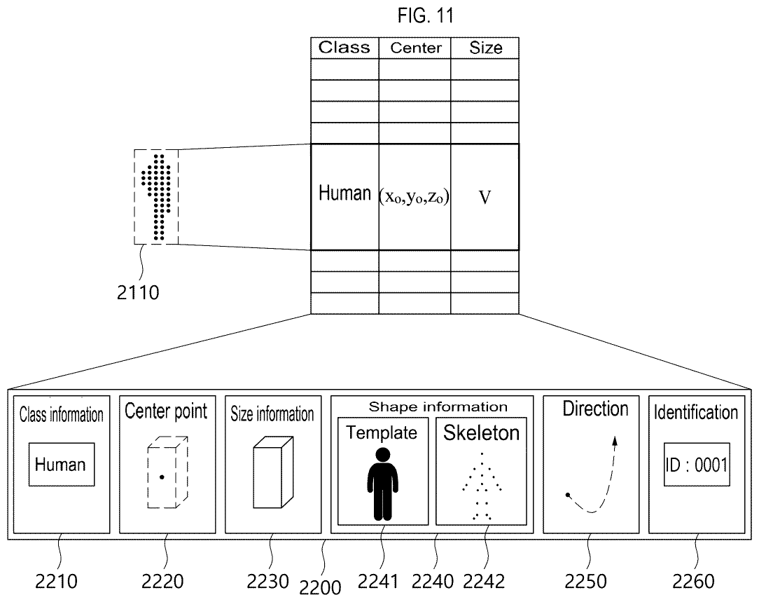

FIG. 11 is a diagram illustrating a plurality of pieces of information included in property data according to an embodiment.

Referring to FIG. 11, the property data 2200 may include a class information 2210, a center position information 2220, a size information 2230, a shape information 2240, a movement information 2250, an identification information 2260 of the like of the object which are represented by the subset of point data 2110, but the present invention is not limited thereto.

In this case, the property data 2200 may be determined based on at least one sub point data set 2110. More specifically, the property data 2200 may include information on various properties of the object represented by the at least one sub point data set 2110, such as the class, size, speed, and direction of the object. Also, the property data 2200 may be data obtained by processing at least a portion of the at least one sub point data set 2110.

In addition, a process of generating the property data 2200 from the sub point data set 2110 included in the point data set 2100 may use a PCL library algorithm.

For example, a first process related to generating the property data 2200 using the PCL (Point Cloud Library) algorithm includes preprocessing a point data set, removing background information, and detecting feature points (feature/keypoint detection), defining a descriptor, matching a feature point, and estimating property of an object may be included, but are not limited thereto.

At this time, the preprocessing the point data set may mean processing the point data set into a form suitable for the PCL algorithm, and in the first process, the object property data included in the point data set 2100 is extracted and irrelevant point data may be removed. For example, preprocessing the data may include removing noise data included in the point data set 2100 and resampling a plurality of point data included in the point data set 2100. However, it is not limited thereto.

In addition, through the removing the background information, in the first process, the background information included in the point data set 2100 may be removed to extract a sub point data set 2110 related to an object.

In addition, through the detecting the feature points, in the first process, a feature point representing a shape characteristic of the object may be detected from among a plurality of point data included in the sub point data set 2110 related to the remaining object after removing the background information.

In addition, through the defining the descriptor, a descriptor capable of explaining the unique characteristics of the feature points detected in the first process may be defined.

In addition, through the matching the feature points, in the first process, a corresponding feature points may be selected by comparing the descriptors of the feature points included in the pre-stored template data related to the object with the descriptors of the feature points of the sub point data set 2110.

In addition, through the estimating the property of the object, the object represented by the sub point data set 2110 may be detected using the geometric relationship of feature points selected in the first process, and the property data 2200 may be generated.

As another example, the second process associated with generating the property data 2200 includes preprocessing data, detecting data about objects, clustering data about objects, classifying cluster data, and tracking the object may include, but is not limited thereto.

At this time, through the detecting the data for the object, a plurality of point data representing the object may be extracted from among the plurality of point data included in the point data set 2100 by utilizing the background data stored in advance in the second process.

In addition, through the clustering the data on the object, in the second process, at least one point data representing one object among the plurality of point data may be clustered to extract the sub point data set 2110.

In addition, through the process of classifying the cluster data, class information of the sub-point data set 2110 may be classified or determined using a machine learning model or a deep learning model previously trained in the second process.

Also, through the tracking the object, the property data 2200 may be generated based on the sub point data set 2110 in the second process. For example, the controller performing the second process may display the location of the object with coordinates and volumes of the center of the plurality of sub point data sets 2110. Accordingly, it is possible to estimate the moving direction and speed of the object by tracking the object by defining a corresponding relationship based on similarity information of distance and shape between a plurality of sub-point data sets obtained in consecutive frames.

2.2. Visualization of Point Cloud Data

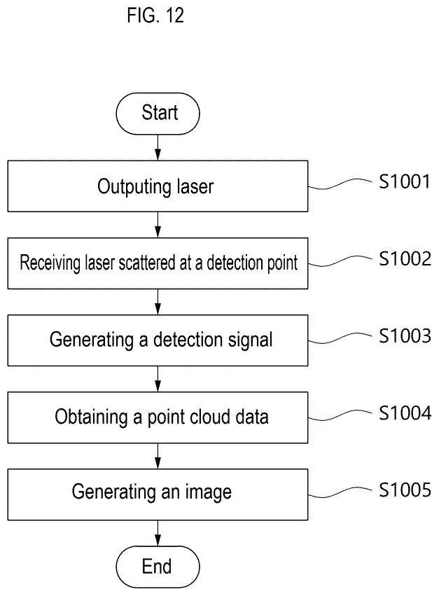

FIG. 12 is a flowchart illustrating a method of generating an image on the basis of point cloud data generated by a LiDAR device according to an embodiment.

Referring to FIG. 12, a LiDAR device according to an embodiment may output a laser output through a laser emitter in step S1001.

In addition, the laser output from the laser emitter may be scattered on at least a portion of an object, and at least a portion of the scattered laser may be received by a detecting unit of the LiDAR device in step S1002.

In addition, the detecting unit may generate a detection signal on the basis of the received laser in step S1003. For example, the LiDAR device may generate the detection signal as an analog signal in the form of a pulse, but no limitation thereto is imposed. The LiDAR device may generate the detection signal as a digital signal in the form of a histogram accumulated in time bins.

In addition, the controller of the LiDAR device may obtain point cloud data on the basis of the detection signal in step S1004. Herein, the controller may generate the point cloud data by frame at a preset frame rate. For example, the controller may match and accumulate point data sets of several frames to obtain overlapped point cloud data, but no limitation thereto is imposed.

In addition, the controller of the LiDAR device may generate 3D image data on the basis of the point cloud data in step S1005. More specifically, the controller may generate a point cloud image by visualizing the overlapped point cloud data. For example, a plurality of pieces of point data included in the point cloud data may be visualized using points in predetermined shapes so that the point data set may be represented in the form of a point cloud image, but no limitation thereto is imposed. Herein, the image may refer to an image resulting from visualization of a point data set of one frame, and the controller may overlap point cloud images of point data sets of a plurality of frames.

For example, the LiDAR device may generate a point cloud image as shown in FIG. 7 on the basis of the point cloud data. More specifically, the LiDAR device may map a plurality of detection points to a pre-stored map, thereby generating a point cloud image for the plurality of detection points. For example, the LiDAR device may generate a point cloud image by mapping points in predetermined shapes to coordinates corresponding to locations of the plurality of detection points on the pre-stored map, but no limitation thereto is imposed.

Hereinafter, on the basis of various types of information obtainable by a LiDAR device, various embodiments of point data constituting a point data set will be described.

3. Various Embodiments of Point Data

Point cloud data generated by a LiDAR device according to an embodiment may include a plurality of pieces of point data. Herein, the LiDAR device may generate a plurality of pieces of point data that respectively correspond to a plurality of detection points at which lasers output from the LiDAR device are scattered.

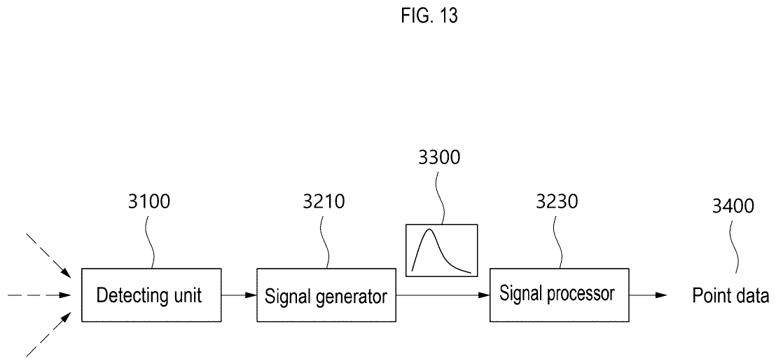

FIG. 13 is a diagram illustrating a configuration of a LiDAR device for generating point data according to an embodiment.

Referring to FIG. 13, a LiDAR device 3000 according to an embodiment may include various configurations for generating point data 3400 corresponding to a detection point on the basis of a detection signal 3300. For example, the LiDAR device 3000 may include a detecting unit 3100, a signal generator 3210, and a signal processor 3230, but is not limited thereto.

The detecting unit 3100 may receive at least a portion of a laser scattered from at least a portion of an object. Specifically, the detecting unit 3100 may receive lasers scattered from a plurality of detection points.

In addition, the signal generator 3210 may generate a detection signal 3300. More specifically, the signal generator 3210 may generate the detection signal 3300 for a detection point on the basis of the laser received through the detecting unit 3100.

In addition, the signal generator 3210 and the detecting unit 3100 may be designed as being integrated. More specifically, the detecting unit 3100 may include a function of receiving the laser as well as generating the detection signal 3300 on the basis of the received laser. In other words, the detecting unit 3100 may include a detecting element for receiving a laser, and a signal generation element for generating an electrical detection signal 3300 on the basis of the laser received by the detecting element, but no limitation thereto is imposed.

In addition, the signal processor 3230 may generate the point data 3400 by processing the detection signal 3300. More specifically, the signal processor 3230 may process the detection signal 3300 on the basis of a predetermined algorithm and may generate point data corresponding to the detection point. For example, the signal processor 3230 may determine a characteristic of the detection signal 3300 and generate the point data 3400 including various types of information on the detection point, but no limitation thereto is imposed.

According to an embodiment, the signal generator 3210 and the signal processor 3230 may be defined as a configuration included in the controller of the LiDAR device.

In addition, the LiDAR device 3000 may obtain various types of information on a plurality of detection points by using the above-described configurations. For example, the LiDAR device 3000 may obtain information on locations, distances, raw intensities, corrected intensities, enhanced intensities, or properties of the plurality of detection points, but no limitation thereto is imposed.

In addition, the LiDAR device may generate the point data 3400 on the basis of a portion of the plurality of pieces of information. For example, the LiDAR device may store at least one piece of information (e.g., location information and intensity information) on each of the plurality of detection points, in the form of a data sheet, thereby obtaining point cloud data including a plurality of pieces of point data.

Hereinafter, types of information that may be included in the point data according to an embodiment will be described.

3.1. Location Information (Position Information) of Detection Points

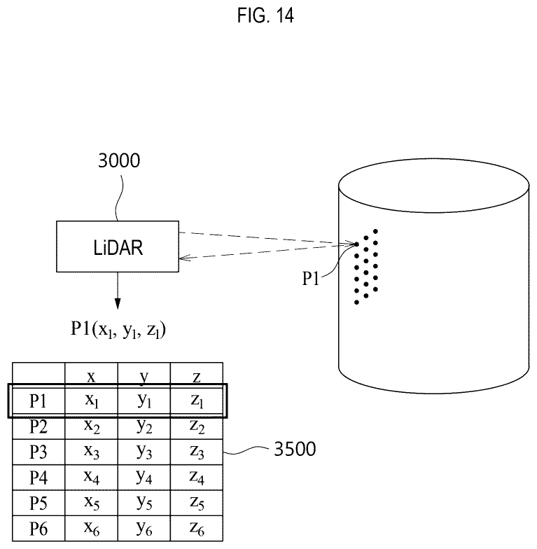

FIG. 14 is a diagram illustrating location information included in point data according to an embodiment.

Referring to FIG. 14, a LiDAR device may generate point data including location information for each of a plurality of detection points. Herein, the location information may be expressed as location coordinates in a coordinate system. More specifically, the location information may be expressed as location coordinates of the detection points relative to the LiDAR device. Herein, the location coordinates are typically coordinates in a rectangular coordinate system (x,y,z), but are not limited thereto. The location coordinates may be coordinates in various coordinate systems, such as a polar coordinate system and a spherical coordinate system, used in the same art. For example, first location information for a first detection point (P1) may be expressed as (x1,y1,z1), but is not limited thereto.

In addition, the LiDAR device may store a plurality of pieces of location information for the plurality of detection points in the form of a data sheet 3500. More specifically, the LiDAR device may calculate location coordinates of each of the plurality of detection points, and may store the location coordinates in the data sheet 3500, thereby generating pieces of point data for the plurality of detection points. For example, the LiDAR device may receive lasers scattered from the plurality of detection points and process the received signals to calculate location information of the plurality of detection points, and may store the pieces of location information in a memory, but no limitation thereto is imposed.

In addition, the location information may reflect distance information from the LiDAR device to a detection point. More specifically, the controller of the LiDAR device may calculate a distance to the detection point on the basis of the flight time of a laser, and may generate location information of the detection point on the basis of the distance. Accordingly, the location information may include distance information to the detection point. For example, the distance information to the detection point may mean a depth of the detection point, and thus may be included in the location information as a z coordinate of the location information, but is not limited thereto.

In addition, the location information may reflect a location of a detector of the LiDAR device. More specifically, when the LiDAR device includes a detector array of a plurality of detectors, the LiDAR device may generate the location information on the basis of the location of the detector that detects a laser in the detector array. For example, the coordinates (x,y) of the location information may be determined on the basis of the location of the detector, but is not limited thereto.

3.2. Intensity Information

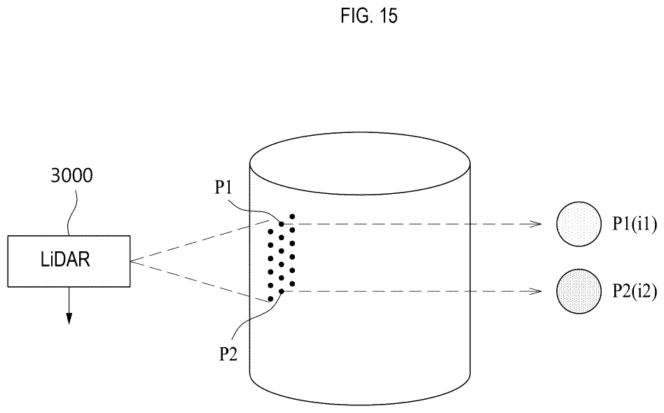

FIG. 15 is a diagram illustrating intensity information according to an embodiment.

Referring to FIG. 15, a LiDAR device 3000 according to an embodiment may generate intensity information for a plurality of detection points. Herein, the intensity information may be information that represents the degrees to which light is reflected by the plurality of detection points. That is, the intensity information may be reflection intensity information of the plurality of detection points. In addition, the intensity information may be expressed as a term such as reflection intensity information, reflectivity information, or reflection information.

In addition, the intensity information may include an intensity value. Herein, the intensity value may be a value resulting from quantifying the degree to which a laser is reflected by a detection point. More specifically, the LiDAR device may calculate an intensity value for each of a plurality of detection points, and may generate intensity information including the intensity values. For example, the LiDAR device 3000 may obtain a first intensity value i1 for a first detection point P1 on the basis of at least a portion of a laser scattered from the first detection point P1. In addition, the LiDAR device 3000 may obtain a second intensity value i2 for a second detection point P2 on the basis of at least a portion of a laser scattered from the second detection point P2.

In addition, an intensity value that the LiDAR device generates may have a predetermined numerical range. More specifically, the LiDAR device may determine an intensity value for a detection point such that the intensity value has a particular value within a predetermined numerical range. For example, the intensity value may be determined within a numerical range of [0,255], but is not limited thereto.

In addition, the LiDAR device may visualize point data corresponding to the detection points on the basis of the intensity information. More specifically, the LiDAR device may calculate an intensity value for each of a plurality of detection points, and may generate a point cloud image reflecting the intensity values. For example, when the first intensity value i1 of the first detection point P1 is greater than the second intensity value i2 of the second detection point P2, the LiDAR device 3000 may represent a point indicative of the first detection point P1 as brighter than a point indicative of the second detection point P2, but no limitation thereto is imposed.

The LiDAR device 3000 may use an intensity value obtained for a point of a detection target detected by a detector unit and may obtain information on optical characteristics of the point of the detection target. The optical characteristics may include color, and brightness.

For example, the LiDAR device may pre-store a matching table for converting an intensity value into color and brightness, and may use the matching table and the obtained intensity value to obtain optical characteristic information of the point of the detection target.

Herein, when generating a point cloud image corresponding to the predetermined detection point, the LiDAR device may enable the point cloud image to reflect the optical characteristic information obtained as described above.

In addition, the intensity information may be determined by various factors related to the intensity of a laser received by the LiDAR device. More specifically, the intensity information may be determined depending on a distance to an object, reflectivity, or material. For example, a relatively large intensity value may be measured for an object of a metal material that is located at a short distance, has white color with high reflectivity, and mainly causes retro-reflection. Conversely, a relatively small intensity value may be measured for an object that is located at a long distance, has black color with low reflectivity, and has a Lambertian surface mainly causing diffuse reflection.

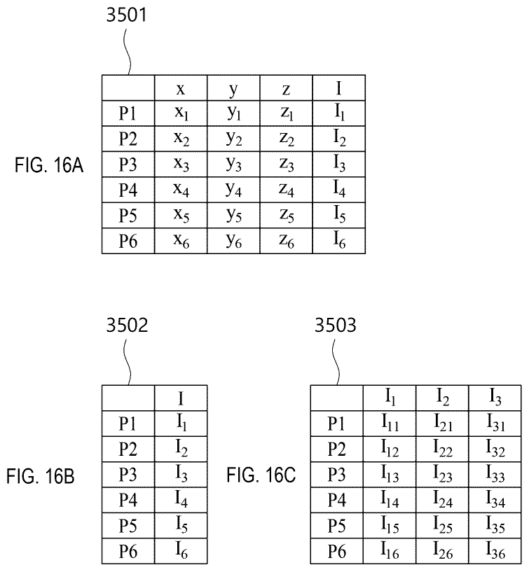

FIG. 16 is a diagram illustrating a method of storing intensity information according to an embodiment.

Referring to FIG. 16, a LiDAR device may represent intensity information in the form of a data sheet.

The LiDAR device may include the intensity information in point data. More specifically, the LiDAR device may generate point data including location information for detection points as well as intensity information for the detection points.

For example, referring to FIG. 16A, the LiDAR device may obtain point cloud data including location information and intensity information of each of a plurality of detection points for each of the plurality of detection points. Herein, the LiDAR device may represent the point cloud data as a data sheet 3501 including location information and intensity information for each of the detection points, but no limitation thereto is imposed.

In addition, the LiDAR device may obtain the intensity information as data independent of point data. More specifically, separately from point data including location information for detection points, the LiDAR device may generate intensity information for the detection points.

For example, referring to FIG. 16B, the LiDAR device may generate and store intensity information for each of the detection points. Herein, the LiDAR device may represent the intensity information as a data sheet 3502 separate from location information, but no limitation thereto is imposed.

In addition, the LiDAR device may obtain a plurality of pieces of intensity information. More specifically, when the LiDAR device is able to obtain one or more pieces of intensity information of a plurality of detection points, the LiDAR device may generate an intensity set including the one or more pieces of intensity information.

For example, referring to FIG. 16C, the LiDAR device may generate and store an intensity set including a plurality of pieces of intensity information of each of the detection points. Herein, the LiDAR device may generate the intensity set as data separate from point data including location information, but no limitation thereto is imposed. The LiDAR device may generate the intensity set as data included in the point data. In addition, the LiDAR device may represent the intensity set as a data sheet 3503, but no limitation thereto is imposed.

In addition, referring back to FIGS. 15 and 16, the LiDAR device may quantify and represent the intensity information. More specifically, the LiDAR device may calculate an intensity value for each of the plurality of detection points, and may generate intensity information including a plurality of intensity values.

Herein, the intensity values may be derived in various forms. For example, the intensity values may include a raw intensity (raw-intensity value), a corrected intensity (corrected-intensity value), or an enhanced intensity, but are not limited thereto.

Herein, the raw intensity may be an intensity value not processed. Specifically, the LiDAR device may generate the raw intensity on the basis of a detection signal.

In addition, the corrected intensity and the enhanced intensity may be intensity values processed on the basis of the raw intensity. More specifically, the LiDAR device may generate the corrected intensity or the enhanced intensity on the basis of the raw intensity.

Hereinafter, limitations of a raw intensity will be described in terms of why a corrected intensity or an enhanced intensity is needed, and different types of intensity values that the LiDAR device is able to generate will be described accordingly.

3.2.1. A Raw Intensity (Raw-Intensity Value)

3.2.1.1. Generation of a Raw Intensity (Raw-Intensity Value)

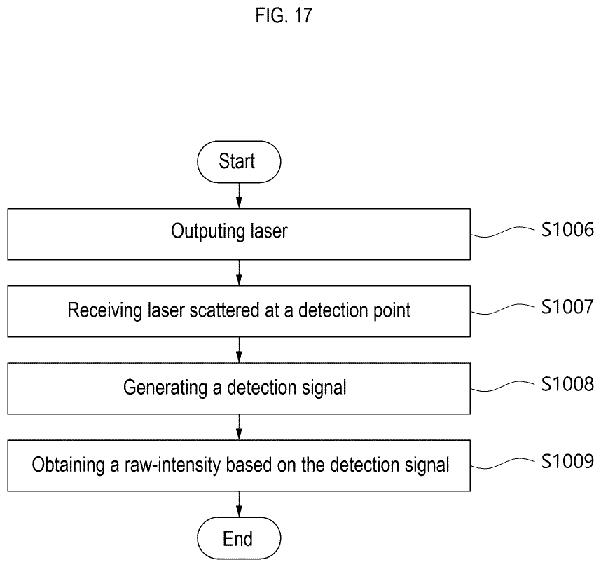

FIG. 17 is a flowchart illustrating a method of generating a raw intensity by a LiDAR device according to an embodiment.

Referring to FIG. 17, a LiDAR device according to an embodiment may transmit a laser in step S1006. In addition, the LiDAR device may receive light scattered at at least one detection point in step S1007. In addition, the LiDAR device may receive the laser to generate the detection signal in step S1008. A detailed description of each of the above steps will be omitted as described above.

In addition, the LiDAR device may obtain a raw intensity (raw-intensity value) on the basis of the detection signal in step S1009. More specifically, the LiDAR device may obtain a raw intensity corresponding to each of the at least one detection point. Herein, the raw intensity may represent a reflection intensity of a detection point. More specifically, the raw intensity may represent the degree to which the detection point reflects light. For example, the raw intensity may be a value proportional to the amount of laser light scattered from the detection point, but is not limited thereto.

3.2.1.2. Reflection Information of a Raw Intensity (Raw-Intensity Value)

The raw intensity that a LiDAR device according to an embodiment generates for a detection point at which a laser is scattered may reflect various types of information. For example, the raw intensity may reflect information related to a location relationship between the detection point and the LiDAR device, information related to the characteristic of the detection point, or information related to an external environment, but is not limited thereto.

For example, the raw intensity generated by the LiDAR device may reflect information related to a location relationship between the LiDAR device and a detection point. As a specific example, the raw intensity may reflect a distance between the LiDAR device and the detection point, and an incident angle of the laser emitted by the LiDAR device on the detection point, but is not limited thereto.

The raw intensity generated by the laser detected by the LiDAR device may reflect various types of information. That is, the generated raw intensity may be a function determined by various variable values. For example, a raw-intensity value may be a function value determined by 1) a distance between a LiDAR device and a detection point of an object that reflects (scatters) a laser, 2) an incident angle of a laser onto a surface of an object, and 3) a property of a surface of an object (e.g., intrinsic reflection, color, etc.).

Hereinafter, the various variables that affect the raw intensity will be described.

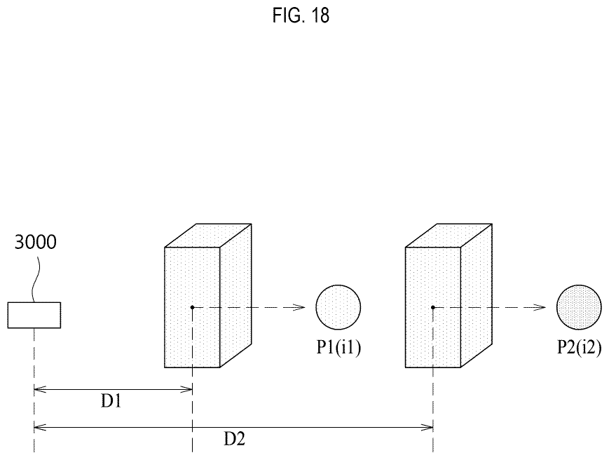

FIG. 18 is a diagram illustrating change in a raw intensity depending on distance information between a LiDAR device according to an embodiment and a detection point.

The raw intensity for a detection point obtained by the LiDAR device may reflect distance information from the LiDAR device to the detection point.

In addition, the raw intensity obtained by the LiDAR device may have values varying depending on a distance between the LiDAR device and a detection point when the LiDAR device receives lasers scattered at objects having the same property. More specifically, when the LiDAR device emits lasers at the same incident angle toward two objects having the same property, raw-intensity values of detection points of the respective objects at which the lasers are scattered may be different from each other. This is because the distances from the LiDAR device to the respective objects are different from each other.

More specifically, referring to FIG. 18, it is assumed that there are a first item and a second item in the direction in which the LiDAR device 3000 emits a laser and a distance between the first item and the LiDAR device is different from a distance between the second item and the LiDAR device, and that the property of the first item and the property of the second item are the same.

The laser emitted from the LiDAR device 3000 is scattered by a first detection point P1 of the first item and scattered by a second detection point P2 of the second item. A portion of the scattered lasers may return to the LiDAR device. Accordingly, the LiDAR device may detect a portion of the laser that has been scattered and has returned from the first detection point P1, and may also detect a portion of the laser that has been scattered and has returned from the second detection point P2.

The LiDAR device may sense a portion of the scattered laser to generate a raw-intensity value for each scattered laser. For convenience, in the following description, an intensity value generated by the laser scattered and returned by the first detection point is referred to as a first intensity value i1, and an intensity value generated by the laser scattered and returned by the second detection point is referred to as a second intensity value i2.

Herein, when a distance between the first detection point P1 and the LiDAR device is a first distance D1 and a distance between the second detection point P2 and the LiDAR device is a second distance D2 and the second distance is greater than the first distance, the first intensity value i1 is greater than the second intensity value i2 as described above.

In addition, the LiDAR device 3000 may determine, on the basis of a raw intensity, a visual characteristic of a point corresponding to a detection point in a point cloud image. More specifically, the LiDAR device 3000 may use a point having brightness corresponding to a raw intensity to visualize a detection point in a point cloud image. For example, the LiDAR device 3000 may visualize the first detection point P1 on the basis of the size of the first raw-intensity value i1, and may visualize the second detection point P2 on the basis of the size of the second raw-intensity value i2. In this case, the first raw-intensity value i1 is greater than the second raw-intensity value i2, so the point corresponding to the first detection point P1 in the point cloud image may be brighter than the point corresponding to the second detection point P2. In other words, the greater the raw intensity for a detection point, the brighter the detection point visualized by the LiDAR device as a point in the point cloud image.

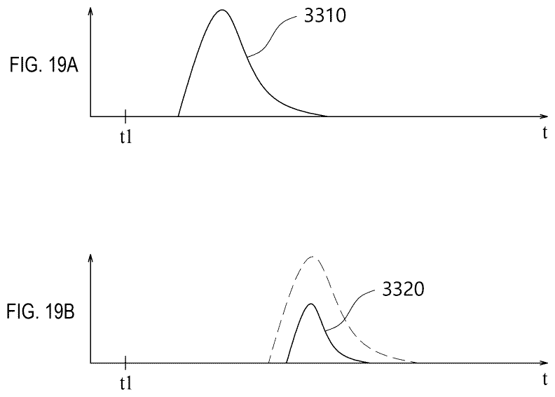

FIG. 19 is a diagram illustrating a difference between detection signals generated for detection points at different distances by the LiDAR device of FIG. 18.

The LiDAR device may obtain a raw intensity on the basis of a characteristic of a detection signal. For example, the LiDAR device may obtain the raw intensity on the basis of a pulse width of the detection signal, but no limitation thereto is imposed. The LiDAR device may obtain the raw intensity on the basis of a pulse area, a peak, a rising edge, or a falling edge of the detection signal.

Referring to FIGS. 18 and 19A, the LiDAR device 3000 at the first distance D1 from the first detection point P1 may receive at least a portion of the laser scattered at the first detection point P1 to generate a first detection signal 3310. Herein, the LiDAR device 3000 may obtain the raw intensity for the first detection point P1 on the basis of the characteristic of the first detection signal 3310. For example, the LiDAR device 3000 may obtain the first raw-intensity value i1 on the basis of a pulse width of the first detection signal 3310, but no limitation thereto is imposed.

In addition, referring to FIGS. 18 and 19B, the LiDAR device 3000 at the second distance D2, which is longer than the first distance D1, from the second detection point P2 may receive at least a portion of the laser scattered at the second detection point P2 to generate a second detection signal 3320.

Herein, the time interval from a laser output time point tI of the LiDAR device to a time point at which the first detection signal 3310 is detected may be shorter than the time interval from the laser output time point tI to a time point at which the second detection signal 3320 is detected. This is because the shorter the distance from the LiDAR device to the detection point, the shorter the flight time of the corresponding laser.

Herein, the LiDAR device 3000 may obtain the second raw-intensity value i2 on the basis of the characteristic of the second detection signal 3320. For example, the LiDAR device 3000 may obtain the second raw-intensity value i2 on the basis of a pulse width (or pulse area) of the second detection signal 3320, but no limitation thereto is imposed. Herein, the pulse width (or pulse area) of the second detection signal 3320 may be smaller than the pulse width (or pulse area) of the first detection signal 3310. This is because the longer the distance between the LiDAR device 3000 and the first detection point P1, the less the amount of laser light received by the LiDAR device 3000.

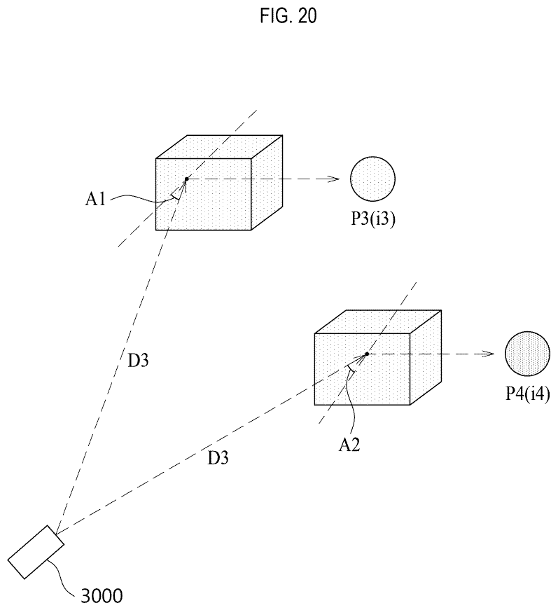

FIG. 20 is a diagram illustrating change in a raw intensity depending on an incident angle of a laser emitted to a detection point by a LiDAR device according to an embodiment.

The raw intensity for a detection point obtained by the LiDAR device may reflect incident angle information of the laser emitted to the detection point from the LiDAR device.

In addition, the raw intensity obtained by the LiDAR device may have values varying depending on an incident angle at which a laser is emitted to a detection point even when the LiDAR device receives lasers scattered from items having the same property. More specifically, when the LiDAR device emits lasers at different incident angles toward detection points at a predetermined distance, raw-intensity values for the detection points may vary.

For example, referring to FIG. 20, the LiDAR device 3000 may emit lasers at different incident angles toward a third detection point P3 and a fourth detection point P4 at the same distance from the LiDAR device 3000. Specifically, a laser may be emitted at a first incident angle A1 from the LiDAR device 3000 to the third detection point P3, and a laser may be emitted at a second incident angle A2 greater than the first incident angle A1 to the fourth detection point P4. Herein, the third detection point P3 and the fourth detection point P4 are at least portions of the two objects having the same property, and may be separated from the LiDAR device 3000 by a third distance D3.

For example, the LiDAR device 3000 may receive at least a portion of the laser scatter from the third detection point P3 to generate a third raw-intensity value i3 for the third detection point P3. In addition, the LiDAR device 3000 may receive at least a portion of the laser scattered from the fourth detection point P4 to generate a fourth raw-intensity value i4 for the fourth detection point P4. In this case, the third raw-intensity value i3 may be greater than the fourth raw-intensity value i4. This is because the greater the incident angle at which emission takes place from the LiDAR device to a detection point, the less the amount of laser light scattered from the detection point and returned to the LiDAR device. In addition, accordingly, a point corresponding to the third detection point P3 in a point cloud image may be brighter than a point corresponding to the fourth detection point P4.

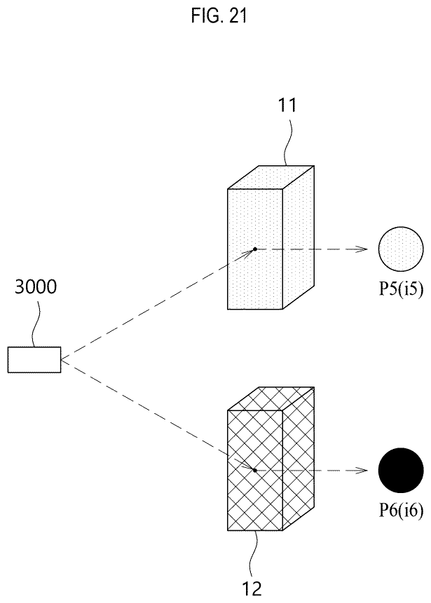

FIG. 21 is a diagram illustrating change in a raw intensity depending on a property of an object to which a laser is emitted by a LiDAR device according to an embodiment.

The raw intensity for a detection point obtained by the LiDAR device may reflect property information of an object (or detection point) to which a laser is emitted. Herein, the property information of the object may include the material, color, or transparency of the object, but is not limited thereto. In other words, the raw intensity for a detection point obtained by the LiDAR device may be determined depending on a property of the detection point.

For example, referring to FIG. 21, the LiDAR device 3000 may emit lasers respectively to a first object 11 and a second object 12 having different properties. In this case, the first object 11 and the second object 12 may have different degrees of scattering emitted light. Herein, the degree of scattering light may include retro-reflection or reflectivity of an object. Specifically, the amount of laser light that is emitted from the LiDAR device 3000 and reflects back to the LiDAR device 3000 may differ between the first object 11 and the second object 12.

For example, when the first object 11 reflects more light than the second object 12, the raw intensity of the first object 11 may be greater than the raw intensity of the second object 12. More specifically, when a laser emitted from the LiDAR device 3000 is scattered from a fifth detection point P5 of the first object 11 and a sixth detection point P6 of the second object 12, the LiDAR device 3000 may receive the scattered laser to generate a fifth raw-intensity value i5 for the fifth detection point P5 and a sixth raw-intensity value i6 for the sixth detection point P6. Herein, the first object 11 has a property of reflecting light better than the second object 12, so the fifth intensity value i5 may be greater than the sixth raw-intensity value i6.

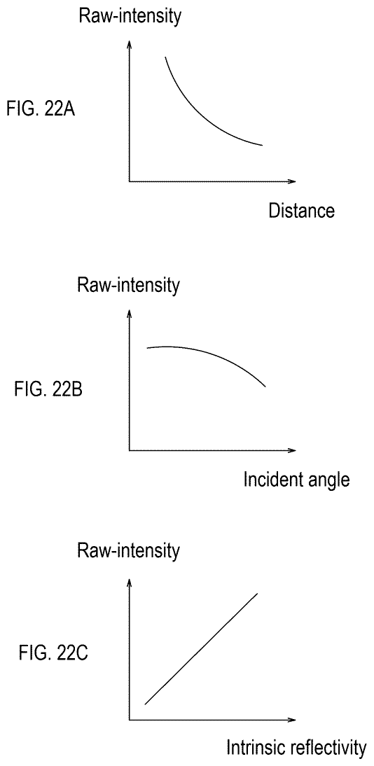

FIG. 22 is a diagram illustrating a correlation between a raw intensity generated by a LiDAR device according to an embodiment and information reflected by the raw intensity.

Referring to FIG. 22A, the greater a distance between the LiDAR device and a detection point, the less the raw intensity for the detection point generated by the LiDAR device. That is, the raw intensity for the detection point generated by the LiDAR device may have an inversely proportional relationship with the distance between the LiDAR device and the detection point. For example, the raw intensity for the detection point generated by the LiDAR device may be inversely proportional to the square or fourth power of the distance between the LiDAR device and the detection point, but no limitation thereto is imposed.

In addition, referring to FIG. 22B, the greater an incident angle of a laser emitted by the LiDAR device to a detection point, the less the raw intensity for the detection point. That is, the raw intensity for the detection point generated by the LiDAR device may have a relationship in the form of a decreasing function with respect to the incident angle of the laser incident onto the detection point.

In addition, referring to FIGS. 22A and 22B, sensitivity of the raw intensity obtained by the LiDAR device to the distance may be greater than sensitivity to the incident angle. For example, the degree to which the raw intensity of a detection point included in a predetermined object decreases as the distance from the LiDAR device to the detection point increases may be greater than the degree to which the raw intensity decreases as the incident angle of the laser emitted to the detection point increases, but no limitation thereto is imposed. In other words, the raw intensity obtained by the LiDAR device may reflect distance information to the detection point more than incident angle information of the laser emitted to the detection point. According to an embodiment, at a predetermined distance or above and at a predetermined incident angle or above, the sensitivity to the incident angle may be greater. The sensitivity may be determined depending on a type of a LiDAR device and surrounding environment at the time of an experiment, so according to an embodiment, the sensitivity to an incident angle may be greater than the sensitivity to a distance.

In addition, the amount of light reflected by the object may be determined depending on property information of the object at which a laser is scattered. Specifically, when the object is made of a material that reflects light well, the amount of laser light reflected by the object may be relatively greater than the amount of laser light absorbed into the object. Herein, the amount of laser light reflected by the object compared to the amount of laser light emitted to the object may be defined as the intrinsic reflectivity of the object.

For example, referring to FIG. 22C, the greater the intrinsic reflectivity of an object to which a laser is emitted, the greater the raw intensity obtained by the LiDAR device. More specifically, when the object is made of a material that reflects light well, the raw intensity for the object may be high. For example, the raw intensity obtained by the LiDAR device may be proportional to the intrinsic reflectivity of the object, but no limitation thereto is imposed.

In addition, the raw intensity obtained by the LiDAR device may reflect environment information surrounding the LiDAR device and a detection point. More specifically, the raw intensity may be determined depending on the medium or density of the space surrounding the LiDAR device and the detection point.

3.2.1.3. Limitations of a Raw Intensity (Raw-Intensity Value)

As described above, the raw intensity obtained by the LiDAR device may reflect various types of information related to the LiDAR device and a detection point. As the raw intensity is determined by reflecting the various types of information, there may be some limitations in using the raw intensity as intensity information for a detection point.

First, a raw intensity is a poor reference of representing the degree to which light is reflected by an object. Although a raw intensity is a value generated by receiving a laser reflected by a detection point, varying a distance from the LiDAR device and an incident angle at which the laser is emitted may generate different values for objects having the same property. In other words, it is difficult for a raw intensity to represent an intrinsic reflection characteristic of an object reflecting a laser.

To solve this, the LiDAR device may correct the raw intensity using a predetermined algorithm. In addition, the LiDAR device may correct the raw intensity to generate a corrected intensity that reflects an intrinsic reflection characteristic of an object. More specifically, the LiDAR device may generate a corrected intensity by correcting the raw intensity so that the same intensity value is generated for objects having the same property.

Details of the corrected intensity will be described below (section 3.2.2.).

In addition, it is difficult for the LiDAR device to visualize the shape of an object with a three-dimensional effect through a raw intensity. Visual information seen through a real camera or eye is viewed with different degrees of brightness even for the same object because of a difference in shade caused by the direction of a light source, thus reflecting a three-dimensional effect. However, the LiDAR device has limitations in visualizing an object in a shape close to the actual shape by reflecting a three-dimensional effect, such as shade, of an object through location information and a raw intensity. This is because a raw intensity, which is an element expressing brightness on the basis of reflection of an object, is unable to accurately represent a visual difference depending on the shape of the object and the location of the light source. Specifically, a raw intensity obtained by the LiDAR device is a value that reflects distance information, incident angle information, and property information, but the degree to which the incident angle information is reflected is smaller than the degrees to which the other pieces of information are reflected. Thus, it may be difficult to visualize a three-dimensional effect or a difference in shade determined by the difference between incident angles through the raw intensity.

To solve this, the LiDAR device may enhance a raw intensity using a predetermined algorithm. In addition, the LiDAR device may enhance the raw intensity to generate an enhanced intensity so that the shape of an object is visualized close to the actual shape. More specifically, the LiDAR device may enhance a raw intensity on the basis of a predetermined algorithm to reflect incident angle information more, thereby generating an enhanced intensity for representing the actual shape of an object, such as shade.

Details of the enhanced intensity will be described below (section 3.2.3.).

Depending on the purpose, the LiDAR device may use a raw intensity to generate i) a corrected intensity to determine an intrinsic reflection intensity of an object, or ii) an enhanced intensity to visualize the shape of an object with a three-dimensional effect. According to an embodiment, an enhanced intensity may be generated by enhancing a corrected intensity, or a corrected intensity may be generated by correcting an enhanced intensity.

Hereinafter, a generation method and utilization of each the corrected intensity and the enhanced intensity will be described.

3.2.2. A Corrected Intensity (Corrected-Intensity Value)

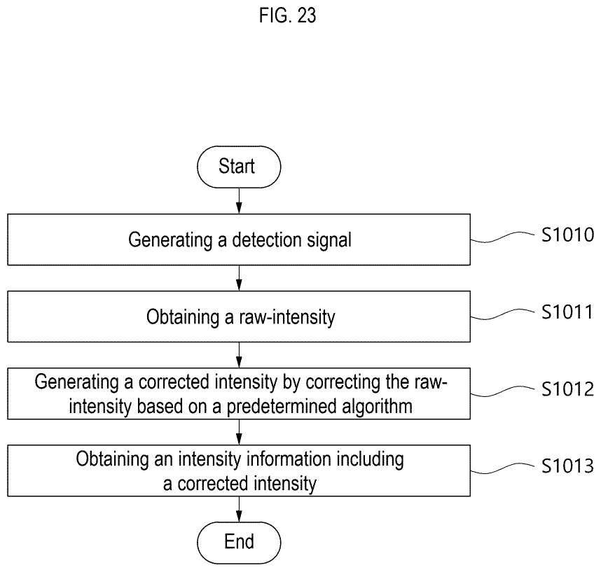

FIG. 23 is a flowchart illustrating a method of generating a corrected intensity by a LiDAR device according to an embodiment.

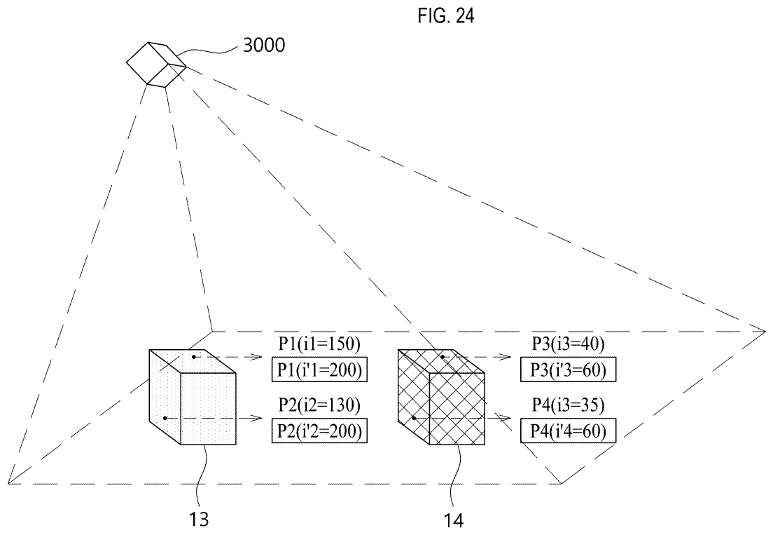

FIG. 24 is a diagram illustrating a raw intensity and a corrected intensity obtainable for a detection point by a LiDAR device according to an embodiment.

Referring to FIG. 23, the LiDAR device may receive a laser scattered at a detection point to generate a detection signal in step S1010. In addition, the LiDAR device may generate a raw intensity for the detection point on the basis of the detection signal in step S1011. In addition, the LiDAR device may correct the raw intensity on the basis of a predetermined algorithm to generate a corrected intensity in step S1012. In addition, the LiDAR device may obtain intensity information including the corrected intensity in step S1013.

Referring to FIG. 24, the LiDAR device 3000 may emit lasers to obtain information on a first object 13 and a second object 14 that are present in a scannable area 20, and the first object and the second object have different properties. More specifically, the LiDAR device 3000 may emit lasers, and may receive lasers scattered from a first detection point P1 and a second detection point P2 included in the first object 13 and a third detection point P3 and a fourth detection point P4 included in the second object 14 that are present within the scannable area 20. In addition, in this case, the LiDAR device 3000 may obtain location information and intensity information for each of the detection points.

Herein, the intensity information may include at least one intensity value. More specifically, the LiDAR device 3000 may obtain intensity information that includes a raw intensity i or a corrected intensity i′ resulting from correcting the raw intensity i for at least one detection point.

Referring back to steps S1010 and S1011 of FIG. 23 and FIG. 24, the LiDAR device 3000 may generate raw intensities by generating detection signals on the basis of lasers reflected by the detection points included in the first object 13 and the detection points included in the second object 14, wherein the first object 13 and the second object 14 have different properties. A detailed method of generating a raw intensity on the basis of a detection signal by a LiDAR device has been described above, so will be omitted.

For example, the LiDAR device 3000 may generate a first raw-intensity value (i1=150) for a first detection point P1, a second raw-intensity value (i2=130) for a second detection point P2, a third raw-intensity value (i3=40) for a third detection point P3, and a fourth raw-intensity value (i4=35) for a fourth detection point P4, but no limitation thereto is imposed.

In step S1012 of FIG. 23, the LiDAR device may generate a corrected intensity in various ways. More specifically, the LiDAR device may pre-store various algorithms for generating a corrected intensity on the basis of a raw intensity. For example, the LiDAR device may generate a corrected intensity by performing geometrical correction (geometric correction) or radiometric correction of a detection signal, but no limitation thereto is imposed.

The purpose of generating a corrected intensity by a LiDAR device may be to obtain a reflection intensity for a detection point more consistently. More specifically, the purpose may be to obtain the same intensity information for at least one detection point having the same property even if a distance and an incident angle vary. For example, the LiDAR device may generate a corrected intensity such that intensity information for a predetermined detection point of the same object includes the same value even if a distance to the object and an incident angle of the laser emitted to the detection point vary.

Hereinafter, various embodiments related to a method of generating a corrected intensity by a LiDAR device will be described.

According to an embodiment, a LiDAR device may generate a corrected intensity by performing geometrical correction on the basis of a raw intensity. Herein, geometrical correction may mean correction that minimizes the effect of a location of a detection point and a shape of the detection point included in the raw intensity on the intensity.

A raw intensity obtained by the LiDAR device may be determined by a property of a detection point as well as a distance to the detection point, an incident angle of a laser emitted to the detection point, and an environmental tolerance as described above. Herein, in order to obtain intensity information that represents the degree to which a laser is reflected by a detection point, the LiDAR device needs to minimize the effects of a distance to the detection point and an incident angle. In other words, the LiDAR device may perform geometrical correction for reducing the effects of the distance and the incident angle so as to determine the intrinsic reflectivity of the object including the detection point.

Specifically, regarding a raw intensity obtained by the LiDAR device, the greater the distance and the incident angle, the less the amount of laser light received by the LiDAR device after scattered from the detection point. Accordingly, the LiDAR device may generate a corrected intensity by performing geometrical correction to obtain the same intensity information for a detection point having the same property regardless of a distance and an incident angle.

In addition, according to another embodiment, the LiDAR device may generate a corrected intensity by performing radiometric correction on the basis of a raw intensity.

Herein, radiometric correction may mean a correction method that considers a reflection characteristic determined by an intrinsic property of an object. Specifically, radiometric correction may be a correction method considering the feature that a light-reflected direction or proportion varies depending on a property, such as a material or intrinsic reflectivity, of an object.

For example, the LiDAR device may pre-store a reflection reference. Herein, the reflection reference may mean data obtained by matching an intrinsic reflectivity for each type of an object. As a specific example, the reflection reference may be obtained by using a high-precision detector to measure a reflectivity value for each object at a predetermined reference, and generating a matching table of reflectivity values measured for object types. Accordingly, the LiDAR device may map the obtained raw intensity to the reflection reference to obtain a corrected intensity, but no limitation thereto is imposed.

In step S1013 of FIG. 23, the intensity information generated by the LiDAR device may include the corrected intensity. In addition, no limitation thereto is imposed, and the LiDAR device may generate intensity information including the corrected intensity as well as a raw intensity. More specifically, as the intensity information generated by the LiDAR device, the corrected intensity and the raw intensity for each of a plurality of detection points may be stored in the form of a data sheet.

For example, referring to FIG. 24, the LiDAR device 3000 may generate corrected intensities for detection points on the basis of one of the predetermined correction methods.

Specifically, the LiDAR device 3000 may obtain intensity information including corrected-intensity values for the first detection point P1 and the second detection point P2 included in the first object 13 having the same property. For example, the controller of the LiDAR device 3000 may obtain a first raw intensity (i1=150) and a first corrected-intensity value (i′1=200) for the first detection point P1, and a second raw intensity (i2=130) and a second corrected-intensity value (i′2=200) for the second detection point P2. Herein, since the first detection point P1 and the second detection point P2 have the same property, the first corrected-intensity value i′1 and the second corrected-intensity value i′2 may be the same or similar to each other. That is, the first corrected-intensity value i′1 and the second corrected-intensity value i′2 may be values corresponding to the property.

In addition, for example, the controller of the LiDAR device 3000 may obtain intensity information including corrected-intensity values for the third detection point P3 and the fourth detection point P4 included in the second object 14 having the same property. For example, the controller of the LiDAR device 3000 may generate a third raw intensity (i3=40) and a third corrected-intensity value (i′3=60) for the third detection point P3, and a fourth raw intensity (i4=35) and a fourth corrected-intensity value (i′4=60) for the fourth detection point P4. Herein, since the third detection point P3 and the fourth detection point P4 have the same property, the third corrected-intensity value i′3 and the fourth corrected-intensity value i′4 may be the same or similar to each other. That is, the third corrected-intensity value i′3 and the fourth corrected-intensity value i′4 may be values corresponding to the property.

In addition, accordingly, the LiDAR device 3000 may distinguish between objects on the basis of the corrected intensities. More specifically, the controller of the LiDAR device 3000 may obtain, for a plurality of objects, corrected intensities that reflect intrinsic properties of the objects, thereby distinguishing between the plurality of objects. For example, the LiDAR device 3000 may distinguish between the first object 13 and the second object 14 on the basis of intensity information including corrected intensities.

In addition, no limitation thereto is imposed, and the LiDAR device may perform pre-processing on a detection signal on the basis of a predetermined algorithm. For example, the controller of the LiDAR device may obtain more accurate intensity information by performing pre-processing on the detection signal on the basis of an algorithm, such as smoothing or normalization.

For example, the controller of the LiDAR device may remove, from a detection signal, a signal except a signal corresponding to light that is reflected by the detection point and is received. More specifically, the controller may remove, from the detection signal, a signal that is determined as a noise signal on the basis of a predetermined algorithm. For example, the controller may determine, as noise, a signal except a signal corresponding to a profile of a laser emitted from the LiDAR device and may remove the noise from the detection signal, but no limitation thereto is imposed.

As another example, the controller of the LiDAR device may extract a particular section of a detection signal. More specifically, considering an operating range and resolution of a receiver of the LiDAR device, the controller may limit the amount of light determined by the detection signal to a particular section. For example, when the LiDAR device receives light of the intensity section of [0,8000], a particular intensity section of [3000, 5000] may be filtered out, but no limitation thereto is imposed. This may be for the controller to linearly match the signal of the particular intensity section to an intensity value.

3.2.3. An Enhanced Intensity (Enhanced-Intensity Value)

A LiDAR device may generate a raw intensity for a detection point on the basis of a detection signal generated by receiving at least a portion of a laser scattered from the detection point. Herein, the raw intensity may be determined by reflecting a distance to the detection point, an incident angle, or a property.

In this case, in order to further emphasize at least some of various types of information reflected in the raw intensity, the LiDAR device may generate an enhanced intensity by further reinforcing the raw intensity with some of the various types of information to on the basis of a predetermined algorithm. More specifically, depending on the purpose, the LiDAR device may generate an enhanced intensity by selectively reinforcing the raw intensity with a parameter related to a detection point.

For example, in order to visualize the shape of an object in three dimensions, the LiDAR device may generate a geometrically enhanced intensity by reinforcing the raw intensity with a parameter related to a geometrical characteristic of a detection point, but no limitation thereto is imposed.

Hereinafter, a geometrically enhanced intensity obtainable by the LiDAR device will be described in detail.

4. A Geometrically Enhanced Intensity (Geometrically Enhanced-Intensity Value)

4.1. Need for a Geometrically Enhanced Intensity

A LiDAR device may generate a detection signal on the basis of at least a portion of light scattered at a detection point, and may generate a raw intensity on the basis of the detection signal. Herein, the raw intensity may reflect a reflection characteristic and a geometrical characteristic of the detection point.

Herein, the reflection characteristic of the detection point may be a characteristic corresponding to an intrinsic property of the detection point. More specifically, the reflection characteristic of the detection point may mean a proportion of light that is reflected by the detection point and returns to the LiDAR device. The proportion of light that retro—is reflected by the detection point and returns to the LiDAR device may depend on the intrinsic property of the detection point.

In addition, the geometrical characteristic of the detection point may be a characteristic corresponding to an incident angle of a laser emitted to the detection point. More specifically, the geometrical characteristic of the detection point may mean a shape of an area related to the detection point, and depending on the shape of the area related to the detection point, an incident angle of the laser emitted to the detection point may be determined.

In addition, the raw intensity may reflect the reflection characteristic of the detection point more than the geometrical characteristic of the detection point. Accordingly, the raw intensity may be a value representing a reflection characteristic of a detection point, and the LiDAR device may have limitations in representing the geometrical characteristic of the detection point through the raw intensity.

For the above reasons, the LiDAR device may generate a geometrically enhanced intensity on the basis of a raw intensity. Herein, the geometrically enhanced intensity may be a value that represents a reflection characteristic of a detection point as well as a geometrical characteristic of the detection point. For example, the LiDAR device may visualize, on the basis of geometrically enhanced intensities for a plurality of detection points, geometrical shapes of the plurality of detection points close to the actual shapes, but no limitation thereto is imposed.

Hereinafter, a method of generating a geometrically enhanced intensity by a LiDAR device will be described in detail.

4.2. A Method of Generating a Geometrically Enhanced Intensity (Geometrically Enhanced-Intensity Value)

A LiDAR device according to an embodiment may generate a geometrically enhanced intensity for each of a plurality of detection points. Herein, the geometrically enhanced intensity may be one type of an enhanced intensity for emphasizing a geometrical characteristic of each of the plurality of detection points. For example, in order to represent a shape of an object more realistically, the LiDAR device may generate the geometrically enhanced intensities such that directions of lasers emitted from the LiDAR device and geometrical characteristics of a plurality of detection points at which the lasers are scattered are further reflected, but no limitation thereto is imposed.

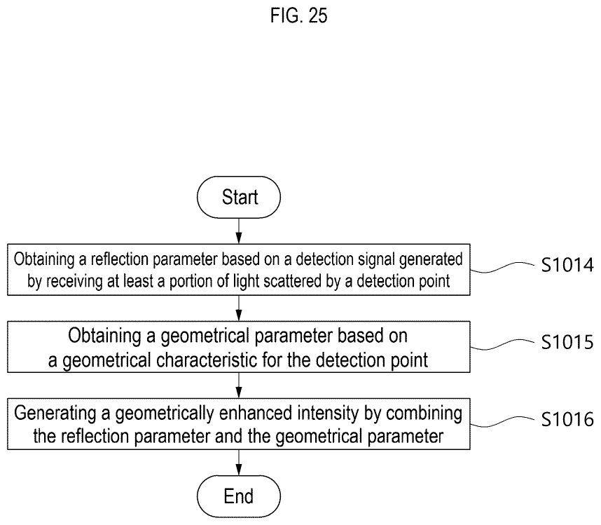

FIG. 25 is a flowchart illustrating a method of generating a geometrically enhanced intensity by a LiDAR device according to an embodiment.

Referring to FIG. 25, the LiDAR device may obtain a reflection parameter (RP) on the basis of a detection signal generated by receiving at least a portion of light scattered at a detection point in step S1014.

In addition, the LiDAR device may obtain a geometrical parameter (geometric parameter, GP) on the basis of a geometrical characteristic (geometric characteristic, GC) of the detection point in step S1015.

In addition, the LiDAR device may generate a geometrically enhanced intensity (geometrically enhanced-intensity value, GEI) by combining the reflection parameter and the geometrical parameter in step S1016.

Hereinafter, a method of generating a geometrically enhanced intensity will be described in more detail with a detailed description of each step of FIG. 25.

4.2.1. A Step of Obtaining a Reflection Parameter

4.2.1.1. Definition of a Reflection Parameter

A reflection parameter (RP) obtained by a LiDAR device according to an embodiment may be a parameter that reflects a reflection characteristic of a detection point. More specifically, the reflection parameter may be generated on the basis of a laser that is reflected by the detection point and is received by the LiDAR device. For example, the LiDAR device may generate a detection signal on the basis of the received laser, and may generate a reflection parameter for the detection point on the basis of the detection signal, but no limitation thereto is imposed.

For example, the reflection parameter may be a raw intensity obtained by the LiDAR device. In addition, as another example, the reflection parameter may be a corrected intensity that is generated by correcting the raw intensity by the LiDAR device, but is not limited thereto.

4.2.1.2. A Method of Generating a Reflection Parameter

Referring to step S1014 of FIG. 25, the LiDAR device may receive at least a portion of light scattered at a detection point to generate a detection signal, and may obtain a reflection parameter on the basis of the detection signal.

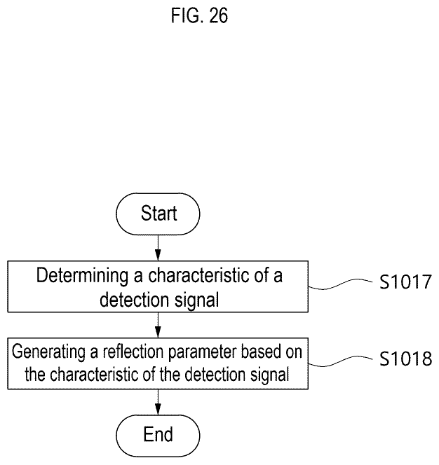

FIG. 26 is a flowchart illustrating a method of generating a reflection parameter by a LiDAR device according to an embodiment.

Referring to FIG. 26, the LiDAR device determine a characteristic of a detection signal in step S1017. Herein, a characteristic of the detection signal may include a pulse width, a pulse area, a peak, a rising edge, or a falling edge of the detection signal, but is not limited thereto.

In addition, the LiDAR device may generate a reflection parameter on the basis of the characteristic of the detection signal in step S1018. More specifically, the LiDAR device may calculate at least one characteristic of the detection signal, and may generate a reflection parameter corresponding to the characteristic of the detection signal. For example, the LiDAR device may calculate a pulse width of the detection signal, and may generate a reflection parameter corresponding to the pulse width of the detection signal, but no limitation thereto is imposed.

In addition, in this case, the reflection parameter may be related to the amount of laser light scattered from the detection point. More specifically, the reflection parameter reflects the reflection characteristic of the detection point, so the reflection parameter may be a value proportional to the amount of laser light or the intensity of a laser scattered from the detection point.

The method of generating a reflection parameter by the LiDAR device may be the same as the method of generating a raw intensity or the method of generating a corrected intensity by the LiDAR device.

4.2.1.3. Use of a Reflection Parameter

A LiDAR device may use the reflection parameter in a variety of ways.

For example, the LiDAR device may generate a geometrically enhanced intensity on the basis of the reflection parameter. A method of generating a geometrically enhanced intensity on the basis of the reflection parameter will be described in detail below.

As another example, the LiDAR device may use the reflection parameter as intensity information. More specifically, the LiDAR device may store a reflection parameter obtained for each of a plurality of detection points as intensity information for the plurality of detection points.

In addition, for example, when generating intensity information including a plurality of intensity values, the LiDAR device may use the reflection parameter as one intensity value included in the intensity information. More specifically, the LiDAR device may store a reflection parameter for each of the plurality of detection points as first intensity information in a data sheet, but no limitation thereto is imposed.

4.2.2. A Step of Obtaining a Geometrical Parameter (Geometric Parameter)

4.2.2.1. Definition and Generation of a Geometrical Parameter

A geometrical parameter (geometric parameter, GP) obtained by a LiDAR device according to an embodiment may be a parameter that reflects a geometrical characteristic of a detection point. More specifically, regardless of the amount of laser light reflected by the detection point, the geometrical parameter may be generated on the basis of a direction of a laser emitted to the detection point and a geometrical shape of the detection point. For example, the LiDAR device may determine the direction of the emitted laser and the geometrical characteristic of the detection point, and may generate a geometrical parameter for the detection point on the basis of the direction of the laser and the geometrical characteristic, but no limitation thereto is imposed. In addition, the geometrical parameter may depend on a geometrical characteristic of a detection point. More specifically, when the direction of a laser emitted from the LiDAR device is constant, a geometrical parameter for a detection point may be determined depending on a geometrical characteristic of the detection point.

Referring to step S1015 of FIG. 25, the LiDAR device may obtain a geometrical parameter on the basis of a geometrical characteristic of a detection point.

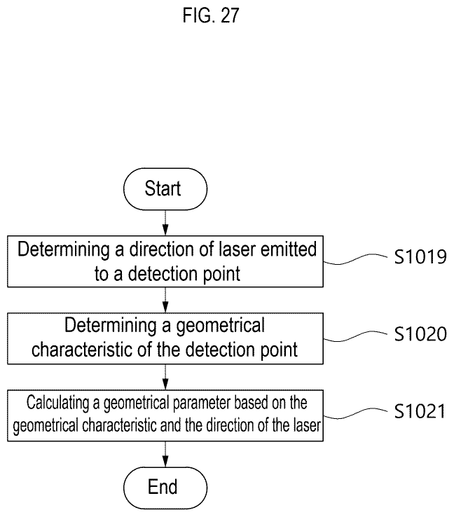

FIG. 27 is a flowchart illustrating a method of generating a geometrical parameter by a LiDAR device according to an embodiment.

Referring to FIG. 27, the LiDAR device may determine a direction of a laser emitted to a detection point in step S1019. In addition, the LiDAR device may determine a geometrical characteristic of the detection point in step S1020. In addition, the LiDAR device may generate a geometrical parameter on the basis of the direction of the laser and the geometrical characteristic in step S1021. The above-described steps are not limited to the order described in FIG. 27 and the present specification, and the order of the steps may be changed according to an embodiment.

Hereinafter, a method of generating a geometrical parameter by a LiDAR device will be described in detail based on each step of FIG. 27.

4.2.2.1.1. A Step of Determining a Direction of a Laser

Referring to step S1019 of FIG. 27, the LiDAR device may determine a direction of a laser emitted to a detection point.

More specifically, the LiDAR device may determine a direction of a laser on the basis of a location of the LiDAR device and location information of a detection point. More specifically, the LiDAR device may determine the direction of the laser by calculating a vector that connects the optical origin of the LiDAR device and location coordinates of the detection point.

In addition, the LiDAR device may determine a direction of a laser on the basis of a preset scan pattern. Herein, the LiDAR device may emit a laser through a laser emitter, and may form a predetermined scan pattern through an optic unit or a scanner. In addition, in this case, the LiDAR device may control a laser emission time point and the operation of the optic unit or the scanner through the controller. Accordingly, the LiDAR device is capable of determining a scanning operation according to a laser emission time point over time, so the LiDAR device may determine a direction of a laser emitted to a detection point in real time.

4.2.2.1.2. A Step of Determining a Geometrical Characteristic

Referring to step S1020 of FIG. 27, the LiDAR device may determine a geometrical characteristic of a detection point. Herein, regarding the geometrical characteristic, a geometrical shape of a predetermined area including the detection point may be represented through an equation or a designation, but is not limited thereto. For example, the geometrical characteristic may be a value representing a geometrical shape of an area related to a detection point, but is not limited thereto.

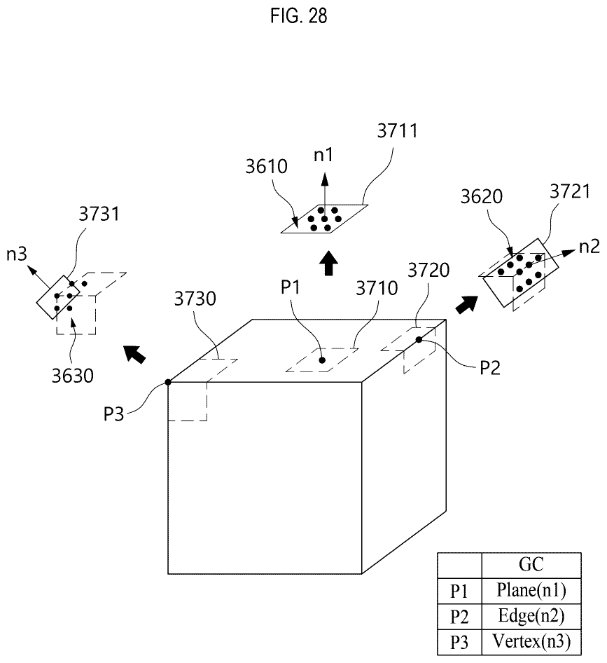

FIG. 28 is a diagram illustrating a geometrical characteristic of a detection point determined by a LiDAR device according to an embodiment.

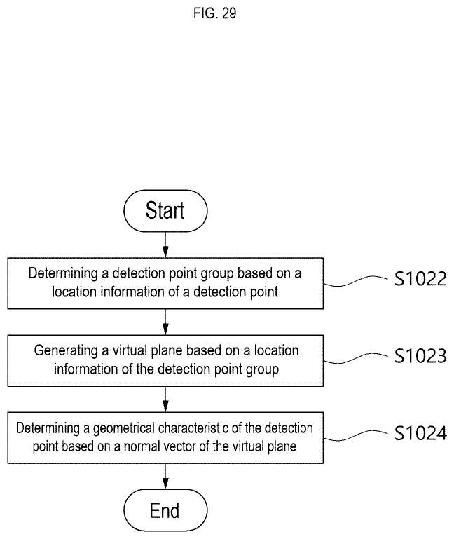

FIG. 29 is a flowchart illustrating a method of determining a geometrical characteristic by a LiDAR device according to an embodiment.

Referring to FIG. 28, a LiDAR device may determine a geometrical characteristic (geometric characteristic, GC) of each of a plurality of detection points. More specifically, the LiDAR device may determine a geometrical characteristic representing a geometrical shape of each of the plurality of detection points. For example, the LiDAR device may determine the geometrical characteristic on the basis of location information of each of the plurality of detection points. More specifically, the LiDAR device may determine a geometrical characteristic by determining a shape of the plurality of detection points on the basis of distribution of location information of each of the plurality of detection points.

For example, the geometrical characteristic may include a normal vector of a virtual plane formed on the basis of a detection point. A method of determining a geometrical characteristic including a normal vector by a LiDAR device is as follows.

Referring to FIG. 29, the LiDAR device may determine a detection point group on the basis of location information of a detection point in step S1022. In addition, the LiDAR device may generate a virtual plane on the basis of location information of the detection point group in step S1023. In addition, the LiDAR device may determine a geometrical characteristic of the detection point on the basis of a normal vector of the virtual plane in step S1024.

In step S1022, in order to determine a geometrical characteristic of a detection point, the LiDAR device may determine, on the basis of location information of the detection point, a detection point group including the detection point and at least one detection point near the detection point. This is because determining a normal vector of the detection point requires determining location information of one or more detection points. For example, referring to FIG. 28, the LiDAR device may determine a first detection point group 3610 including a first detection point P1, a second detection point group 3620 including a second detection point P2, and a third detection point group 3630 including a third detection point P3, but no limitation thereto is imposed. Herein, each of the detection point groups may be determined on the basis of location information of a detection point. For example, the LiDAR device may select, on the basis of location information of a detection point for determining a geometrical characteristic, other detection points within a predetermined distance from the detection point, and may determine the detection point and the selected detection points as one detection point group, but no limitation thereto is imposed.

According to an embodiment, a LiDAR device may perform step S1023 described below without determining a detection point group as in step S1022.

In addition, in step S1023, the LiDAR device may generate a virtual plane on the basis of location information of a detection point group to determine a normal vector for a detection point. Specifically, the LiDAR device may generate a virtual plane by estimating a local plane that is representative of a detection point and points neighboring the detection point, and may determine a normal vector. This is because since a normal vector is generally a vector representing a direction of a plane, it is necessary to generate a virtual plane corresponding to a shape of a detection point in order to determine a normal vector for the detection point.

Specifically, the LiDAR device may generate a virtual plane such that the virtual plane is most adjacent to a plurality of detection points included in the detection point group. In other words, the LiDAR device may generate a virtual plane in which deviations of distances from a plurality of detection points included in the detection point group are minimized.

For example, referring to FIG. 28, the LiDAR device may generate a first virtual plane 3711 on the basis of location information of the first detection point group 3610. Herein, distances from the first virtual plane 3711 to a plurality of detection points included in the first detection point group 3610 may be constant. More specifically, the first detection point group 3610 is located on the same plane of the object, so the distances from the first virtual plane 3711 to the plurality of detection points included in the first detection point group 3610 may be constant. In addition, the distances from the first virtual plane 3610 to the plurality of detection points included in the first detection point group 3610 may be 0, but no limitation thereto is imposed. In addition, the first virtual plane 3610 may be a plane including the first detection point group 3610.

In addition, for example, the LiDAR device may generate a second virtual plane 3721 on the basis of location information of the second detection point group 3620. Herein, distances from the second virtual plane 3721 to a plurality of detection points included in the second detection point group 3620 may be different from each other. This is because the second detection point group 3620 includes the detection points located on different planes of the object. More specifically, since the second detection point group 3620 includes the plurality of detection points on two different planes, the LiDAR device may generate the second virtual plane 3721 intersecting the two planes. In addition, the LiDAR device may generate the second virtual plane 3721 such that deviations of distances from the plurality of detection points included in the second detection point group 3620 are minimized.

In addition, for example, the LiDAR device may generate a third virtual plane 3731 on the basis of location information of the third detection point group 3630. Herein, the third detection point group 3630 includes a plurality of detection points on three different planes, so the LiDAR device may generate the third virtual plane 3731 intersecting the three planes. In addition, the LiDAR device may generate the third virtual plane 3731 such that deviations of distances from the plurality of detection points included in the third detection point group 3630 are minimized.

In addition, in step S1024, the LiDAR device may determine a geometrical characteristic of a detection point on the basis of a normal vector of a virtual plane generated in step S1023. More specifically, the LiDAR device may represent a geometrical characteristic of a detection point as a normal vector of a virtual plane generated on the basis of the detection point. Herein, the LiDAR device may determine, as a normal vector of a detection point, a vector having a smaller angle with the optical origin of the LiDAR device among two normal vectors representing the virtual plane.

For example, referring to FIG. 28, the LiDAR device may represent a geometrical characteristic of a first detection point P1 as a first normal vector n1 of the first virtual plane 3711. In addition, for example, the LiDAR device may represent a geometrical characteristic of a second detection point P2 as a second normal vector n2 of the second virtual plane 3712. In addition, for example, the LiDAR device may represent a geometrical characteristic of a third detection point P3 as a third normal vector n3 of the third virtual plane 3713.

In addition, as another example, the geometrical characteristic may include shape information of a predetermined area including a detection point. More specifically, the LiDAR device may determine, on the basis of location information of one detection point and other detection points near the detection point, shape information of an area including the detection point. For example, the LiDAR device may represent a geometrical characteristic of a detection point as a plane, an edge, or a corner, but no limitation thereto is imposed.

As a specific example, referring to FIG. 28, the LiDAR device may determine a geometrical characteristic (GC) of a plurality of detection points included in an object. Herein, the LiDAR device may determine a geometrical characteristic (GC) for each of the plurality of detection points, but no limitation thereto is imposed. The LiDAR device may determine a geometrical characteristic only for at least some of the plurality of detection points.

For example, the LiDAR device may determine a geometrical characteristic of a first detection point P1 as a plane on the basis of location information of detection points included in a first area 3710 related to the first detection point P1, but no limitation thereto is imposed. Specifically, the LiDAR device may determine that the distribution of location information of a plurality of detection points included in the first area 3710 is close to a plane, and may determine a geometrical characteristic of a first detection point P1 as a plane accordingly.

In addition, for example, the LiDAR device may determine a geometrical characteristic of a second detection point P2 as an edge on the basis of location information of detection points included in a second area 3720 related to the second detection point P2, but no limitation thereto is imposed. More specifically, the LiDAR device may determine that the distribution of location information of a plurality of detection points included in the second area 3720 is close to two intersecting planes. In addition, in this case, the second detection point P2 is present at a point at which two planes intersect on the second area 3720, so the LiDAR device may determine that a geometrical characteristic of the second detection point P2 is an edge at which two planes intersect.

In addition, for example, the LiDAR device may determine a geometrical characteristic of a third detection point P3 as a corner on the basis of location information of detection points included in a third area 3730 related to the third detection point P3, but no limitation thereto is imposed. More specifically, the LiDAR device may determine that the distribution of location information of a plurality of detection points included in the third area 3730 is close to three intersecting planes. In addition, in this case, the third detection point P3 is present at a point at which three planes intersect on the third area 3730, the LiDAR device may determine that a geometrical characteristic of the third detection point P3 is a corner at which three planes intersect.

In addition, although not shown in FIG. 28, the LiDAR device may determine that a geometrical characteristic of a fourth detection point located at a curved surface is a curved surface. More specifically, the LiDAR device may determine that the distribution of location information of a plurality of detection points included in a fourth area related to the fourth detection point is close to a curved surface having a predetermined curvature. In addition, in this case, the LiDAR device may determine that a geometrical characteristic of the fourth detection point is a curved surface.

4.2.2.1.3. A Step of Generating a Geometrical Parameter

Referring to step S1021 of FIG. 27, the LiDAR device may generate a geometrical parameter GP on the basis of a direction of a laser emitted to a detection point and a geometrical characteristic of the detection point.

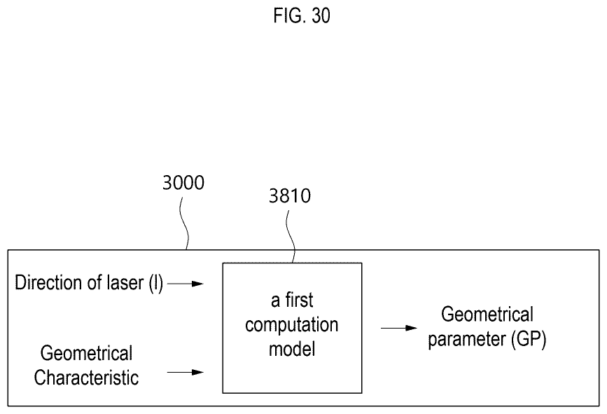

FIG. 30 is a diagram illustrating a method of generating a geometrical parameter by a LiDAR device according to an embodiment.

Referring to FIG. 30, a LiDAR device 3000 may include a first computation model 3810 for generating a geometrical parameter GP. More specifically, the controller of the LiDAR device 3000 may include the first computation model 3810. Herein, the controller of the LiDAR device may input direction (1) information of a laser emitted to a detection point and geometrical characteristic information of the detection point as input data to the first computation model 3810. In addition, the controller may use the first computation model 3810 to perform calculation with direction (1) information of a laser emitted to the detection point and geometrical characteristic information of the detection point in a predetermined computation method and may output a geometrical parameter GP for the detection point as output data.

In addition, the first computation model 3810 included in the LiDAR device 3000 may calculate a geometrical parameter for a detection point on the basis of various computation methods.

A LiDAR device according to an embodiment may compute only a direction of a laser emitted to a detection point and a geometrical characteristic of the detection point on the basis of a predetermined algorithm to calculate a geometrical parameter for the detection point. Herein, the LiDAR device may calculate a geometrical parameter for each of a plurality of detection points to which lasers are emitted in a scan area of the LiDAR device, but no limitation thereto is imposed. A geometrical parameter may be calculated for at least some of the plurality of detection points.

Specifically, the controller of the LiDAR device may generate, on the basis of a normal vector of the detection point and the direction of the laser emitted to the detection point, a geometrical parameter reflecting an incident angle of the laser emitted to the detection point. Herein, the greater the incident angle of the laser emitted to the detection point, the less the geometrical parameter. For example, the greater an angle between the direction of the laser emitted to the detection point and the normal vector of the detection point, the less the geometrical parameter, but no limitation thereto is imposed.

For example, the controller of the LiDAR device may calculate a geometrical parameter GP for a detection point on the basis of [Equation 1] below.

GP=n·1 [Equation 1]
(n: a normal vector of a detection point, and 1: a direction vector of a laser emitted to a detection point)

Referring to [Equation 1], a geometrical parameter generated by a LiDAR device according to an embodiment may be an inner product of a normal vector of a detection point and a direction vector of a laser emitted to the detection point. Accordingly, the geometrical parameter may be inversely proportional to an angle between the normal vector of the detection point and the direction of the laser emitted to the detection point. In other words, the geometrical parameter and the incident angle of the laser emitted to the detection point may have a correlation in the form of a cosine function, but is not limited thereto.

In addition, a LiDAR device according to another embodiment may compute a direction of a laser emitted to a detection point and a geometrical characteristic of the detection point as well as distance information of a detection point and property information of the detection point on the basis of a predetermined algorithm to calculate a geometrical parameter for the detection point.

Specifically, the controller of the LiDAR device may generate a geometrical parameter that reflects an incident angle of a laser emitted to a detection point as well as a property of the detection point and a distance to the detection point.

For example, the controller of the LiDAR device may calculate a geometrical parameter GP for a detection point on the basis of [Equation 2] below.

$$GP = {k}_{d} \frac{( n \cdot I )}{{d}^{2}} \qquad [ Equation 2 ]$$

(kd: a reflection coefficient, d: distance information of a detection point, n: a normal vector of a detection point, and 1: a direction of a laser emitted to a detection point)

Herein, the reflection coefficient kd may be a value representing property information of a detection point. More specifically, the LiDAR device may perform computation such that the geometrical parameter reflects property information of the detection point through the reflection coefficient. For example, the reflection coefficient kd may be determined on the basis of a material, color, or transparency of the detection point, but is not limited thereto.

In addition, the controller of the LiDAR device may calculate a geometrical parameter assuming that a property of a detection point is a Lambetian surface. More specifically, the controller may calculate a geometrical parameter for a detection point on the basis of a reflection coefficient for a Lambetian surface that mainly causes diffuse reflection. That is, regardless of the actual property of the object including the detection point, the LiDAR device may calculate a geometrical parameter assuming that the property of the object is a Lambetian surface.

In addition, the controller of the LiDAR device may pre-store a reflection coefficient kd for each object. More specifically, the controller of the LiDAR device may pre-store a reflection coefficient kd according to a property of an object, so that when computing a geometrical parameter for a detection point included in a predetermined object, the controller may calculate the geometrical parameter on the basis of a reflection coefficient corresponding to the predetermined object.

In addition, a geometrical parameter generated by the LiDAR device according to [Equation 2] may reflect distance information to a detection point. More specifically, the LiDAR device may generate a geometrical parameter reflecting distance information to a detection point in order to generate a point cloud image reflecting a sense of distance. For example, the controller of the LiDAR device may generate a geometrical parameter that is inversely proportional to a distance from the optical origin of the LiDAR device to a detection point or the square of the distance.

4.2.2.2. Use of a Geometrical Parameter

A LiDAR device according to an embodiment may use the geometrical parameter to generate a geometrically enhanced intensity for a detection point. However, the geometrical parameter is not limited to the above use, and the LiDAR device may use the geometrical parameter as independent information for a detection point.

For example, the LiDAR device may set the geometrical parameter as intensity information for a detection point. More specifically, intensity information for a detection point generated by the LiDAR device may include a geometrical parameter for the detection point. For example, point data generated by the LiDAR device for a detection point may include intensity information for the detection point. Herein, the intensity information may include a geometrical parameter for the detection point. In addition, no limitation thereto is imposed, and intensity information generated for the detection point independently of the point data may also include a geometrical parameter for the detection point.

In addition, as another example, when intensity information generated by the LiDAR device includes a number of intensity values, the LiDAR device may include a geometrical parameter as one intensity value. For example, the LiDAR device may generate intensity information that includes a first intensity value represented as a reflection parameter for a detection point and a second intensity value represented as a geometrical parameter for the detection point, but no limitation thereto is imposed.

In addition, as another example, the LiDAR device may represent a geometrical shape of the detection point through the geometrical parameter. More specifically, the geometrical parameter depends on the geometrical shape of the detection point, so the geometrical parameter may be used as a means for representing the geometrical shape of the detection point.

In addition, as another example, the LiDAR device may use the geometrical parameter as shape information of an object including the detection point. More specifically, the LiDAR device may use a geometrical parameter for at least one detection point included in an object to generate shape information of the object. For example, when at least one detection point is included in a predetermined object, the LiDAR device may generate shape information of the object including a geometrical parameter for the at least one detection point, but no limitation thereto is imposed.

In addition, the LiDAR device may use the geometrical parameter as a pixel value for generating an image. Details thereof will be described below.

4.2.3. A Step of Generating a Geometrically Enhanced Intensity

Referring to step S1016 of FIG. 25, a LiDAR device may generate a geometrically enhanced intensity by combining a reflection parameter and a geometrical parameter for a detection point.

Specifically, the controller of the LiDAR device may perform computation to combine a reflection parameter and a geometrical parameter generated for each of a plurality of detection points on the basis of a predetermined algorithm and may generate a geometrically enhanced intensity for each of the plurality of detection points.

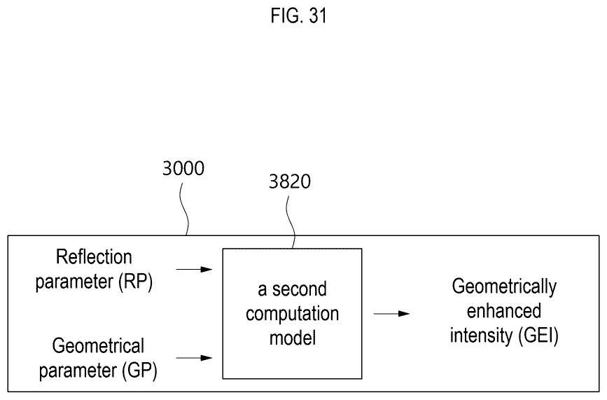

FIG. 31 is a diagram illustrating a method of generating a geometrically enhanced intensity by a controller of a LiDAR device according to an embodiment.

Referring to FIG. 31, a LiDAR device 3000 may include a second computation model 3820 for generating a geometrically enhanced intensity GEI. More specifically, the controller of the LiDAR device 3000 may include the second computation model 3820. Herein, the controller of the LiDAR device may input a reflection parameter RP for a detection point and a geometrical parameter GP for the detection point as input data to the second computation model 3820. In addition, the controller may use the second computation model 3820 to perform calculation with the reflection parameter RP and the geometrical parameter FP in a predetermined computation method and may output a geometrically enhanced intensity GEI for a detection point as output data.

In addition, the second computation model 3820 included in the LiDAR device 3000 may generate a geometrically enhanced intensity on the basis of various computation methods.

For example, the controller of the LiDAR device may generate a geometrically enhanced intensity GEI by linearly combining a reflection parameter RP and a geometrical parameter GP. More specifically, the controller of the LiDAR device may combine the reflection parameter RP and the geometrical parameter GP using a linear computation method such that the geometrically enhanced intensity GEI is proportional to each of the reflection parameter RP and the geometrical parameter GP.

4.2.3.1. A Method of Generating a Geometrically Enhanced Intensity Through Summation

For example, a controller of a LiDAR device may generate a geometrically enhanced intensity GEI by performing summation on a reflection parameter RP and a geometrical parameter GP derived for each of a plurality of detection points. More specifically, the controller may generate a geometrically enhanced intensity GEI by adding a reflection parameter calculated on the basis of the algorithm of FIG. 26 and a geometrical parameter calculated on the basis of the algorithm of FIG. 27. That is, the controller may generate a geometrically enhanced intensity (GEI) value by numerically adding a value of the reflection parameter RP and a value of the geometrical parameter GP, but no limitation thereto is imposed.

4.2.3.2. A Method of Generating a Geometrically Enhanced Intensity Through a Weight

As another example, a controller of a LiDAR device may generate a geometrically enhanced intensity GEI on the basis of a computation method of assigning a weight to each of the reflection parameter RP and the geometrical parameter GP. In other words, the controller of the LiDAR device may determine a weighted sum of the reflection parameter RP and the geometrical parameter GP as a geometrically enhanced intensity GET. In addition, the controller of the LiDAR device may set the at least one weight considering the weight of the reflection parameter RP and the geometrical parameter GP. Herein, the controller may determine the weight considering a ratio of combination of the reflection parameter RP and the geometrical parameter GP. That is, the controller may determine at least one weight and assign the at least one weight to each of the reflection parameter RP and the geometrical parameter GP to generate the geometrically enhanced intensity GEI.

For example, the controller of the LiDAR device may assign a first weight to the reflection parameter RP and may assign a second weight to the geometrical parameter GP to generate the geometrically enhanced intensity GEI. Herein, the controller may set the first weight and the second weight such that the sum of the first weight and the second weight is constant. In other words, the sum of a first weight and a second weight for all detection points may be constant. As a specific example, the controller may set the first weight and the second weight such that the sum of the first weight and the second weight is 1. Herein, when the first weight is represented as ‘x’, the second weight may be represented as ‘1−x’, but no limitation thereto is imposed.

For example, a method of generating a geometrically enhanced intensity GEI through combination of a reflection parameter RP and a geometrical parameter GP may be performed on the basis of [Equation 3].

GEI=αRP+(1−α)GP [Equation 3]
(α: a first weight, and 1−α: a second weight)

Referring to [Equation 3], a geometrically enhanced intensity GEI generated by the LiDAR device may be proportional to a reflection parameter RP and a geometrical parameter GP. Specifically, due to linear combination of a reflection parameter RP and a geometrical parameter GP, the greater the size of each of the reflection parameter RP and the geometrical parameter GP, the greater the size of the geometrically enhanced intensity GEI.

In addition, for example, the LiDAR device may independently assign weights to the reflection parameter RP and the geometrical parameter GP, respectively. More specifically, for each of a plurality of detection points, the sum of a first weight for the reflection parameter RP and a second weight for the geometrical parameter GP may not be constant.

In addition, the LiDAR device may assign the at least one weight on the basis of an experimental method. For example, when the LiDAR device generates an image on the basis of intensity information represented as a geometrically enhanced intensity, the LiDAR device may experimentally extract a weight that best reveals a geometrical characteristic (e.g., shade) of an object from the image.

In addition, the LiDAR device may determine the at least one weight considering property information of a detection point. More specifically, the controller of the LiDAR device may determine the at least one weight considering a material, transparency, or color of the detection point. For example, the LiDAR device may assign, on the basis of a material of a detection point, a first weight for the reflection parameter RP and a second weight for the geometrical parameter GP. Specifically, when the material of the detection point is a material that mainly causes retro-reflection, a first weight may not be assigned and a second weight of a high value may be assigned. In addition, when the material of the detection point is a material that mainly causes diffuse reflection, the first weight of a high value may be assigned and the second weight may not be assigned, but no limitation thereto is imposed.

In addition, the LiDAR device may determine the at least one weight considering incident angle information of a laser emitted to a detection point.

Referring back to FIG. 22B, a raw intensity for a detection point obtained by the LiDAR device may be inversely proportional to an incident angle of a laser emitted to the detection point. In this case, a change rate of the raw intensity for the incident angle may vary according to an incident angle. More specifically, the change rate of the raw intensity in a range within a predetermined angle may be smaller than the change rate of the raw intensity in a range equal to or greater than the predetermined angle. For example, the rate at which the raw intensity decreases as the incident angle increases when the incident angle is less than 60 degrees may be smaller than the rate at which the raw intensity decreases as the incident angle increases when the incident angle is equal to or greater than 60 degrees, but no limitation thereto is imposed.

Considering the characteristic of the change rate of the raw intensity, the LiDAR device may determine at least one weight based on incident angle information. More specifically, within a predetermined angle, a change rate of a raw intensity is small, so the controller of the LiDAR device may assign a second weight of a high value for the geometrical parameter GP in order to increase sensitivity of a geometrically enhanced intensity to an incident angle. In addition, at a predetermined angle or greater, a change rate of a raw intensity is large, so sensitivity of a geometrically enhanced intensity to an incident angle is sufficiently large. Therefore, the controller of the LiDAR device may assign a second weight of a low value for the geometrical parameter GP.

In addition, the LiDAR device may determine the at least one weight on the basis of the distribution of the geometrical parameter GP. More specifically, the controller of the LiDAR device may determine the at least one weight on the basis of the distribution of a geometrical parameter GP for a plurality of detection points present within a scan area. For example, the LiDAR device may determine, on the basis of the distribution of a geometrical parameter GP of a plurality of detection points for a predetermined object, the at least one weight for calculating a geometrically enhanced intensity for the plurality of detection points. As a specific example, in the distribution of a geometrical parameter GP for the predetermined object, the LiDAR device may calculate a difference between a reflection parameter RP of a point with a geometrical parameter GP of 1 and a reflection parameter RP of a point with a geometrical parameter of 2, and may determine the at least one weight on the basis of the difference.

In addition to this, the LiDAR device may determine the at least one weight that reflects a hardware characteristic of the LiDAR device. More specifically, the distribution of the geometrical parameter GP may be determined for each hardware characteristic of the LiDAR device for scanning a detection point. For example, controllers of a plurality of LiDAR devices may pre-store distributions of geometrical parameters GPs of the respective LiDAR devices for a plurality of detection points for a predetermined object, and may perform control such that the respective LiDAR devices set different weights, but no limitation thereto is imposed.

In addition, for example, a controller of a LiDAR device may generate a geometrically enhanced intensity GEI on the basis of a normalization method. Herein, normalization is a term that comprehensively refers to a process of adjusting numerical values of output data to be within a predetermined range.

For example, before combining a reflection parameter RP and a geometrical parameter GP, the LiDAR device may perform normalization on the reflection parameter RP and the geometrical parameter GP. More specifically, the controller of the LiDAR device may perform normalization on the reflection parameter RP and the geometrical parameter GP on the basis of the same numerical range.

Herein, after the reflection parameter RP and the geometrical parameter GP are generated, the controller may perform normalization such that the reflection parameter RP and the geometrical parameter GP have the same numerical range. For example, after the reflection parameter RP and the geometrical parameter GP are calculated, the controller may perform normalization such that the reflection parameter RP and the geometrical parameter GP have a numerical range of [0,255].

In addition, when the reflection parameter RP and the geometrical parameter GP are generated, the controller may perform normalization such that the reflection parameter RP and the geometrical parameter GP have the same numerical range. For example, when the reflection parameter RP and the geometrical parameter GP are calculated, the controller may perform an algorithm for calculating the reflection parameter RP and the geometrical parameter GP such that the reflection parameter RP and the geometrical parameter GP have a numerical range of [0,255].

As another example, the LiDAR device may perform normalization on a geometrically enhanced intensity GEI that is obtained by combining a reflection parameter RP and a geometrical parameter GP. More specifically, the controller of the LiDAR device may perform normalization on the geometrically enhanced intensity GEI such that the geometrically enhanced intensity GEI and the reflection parameter RP have the same numerical range.

Herein, after the geometrically enhanced intensity GEI is generated, the controller may perform normalization such that the geometrically enhanced intensity GEI and the reflection parameter RP and/or the geometrical parameter GP have the same numerical range. For example, after the geometrically enhanced intensity GEI is calculated, the controller may perform normalization such that the geometrically enhanced intensity GEI and the reflection parameter RP have the same numerical range of [0,255].

In addition, when the geometrically enhanced intensity GEI is generated, the controller may perform normalization such that the geometrically enhanced intensity GEI and the reflection parameter RP and/or the geometrical parameter GP have the same numerical range. For example, when the geometrically enhanced intensity GEI is calculated, the controller may perform an algorithm for calculating the geometrically enhanced intensity GEI by combining the reflection parameter RP and the geometrical parameter GP such that the geometrically enhanced intensity GEI and the reflection parameter RP have the same numerical range of [0,255].

In addition, when the geometrically enhanced intensity GEI is generated, the controller may assign at least one weight such that the geometrically enhanced intensity GEI and the reflection parameter RP and/or the geometrical parameter GP have the same numerical range. For example, when the geometrically enhanced intensity GEI is calculated, the controller may assign a first weight for the reflection parameter RP and a second weight for the geometrical parameter GP such that the geometrically enhanced intensity GEI and the reflection parameter RP have the same numerical range of [0,255].

Hereinafter, effects of using a geometrically enhanced intensity as intensity information for a detection point will be described.

4.3. Effects of a Geometrically Enhanced Intensity

A LiDAR device according to an embodiment may combine a raw intensity for a detection point and a parameter that considers shape information of the detection point, thereby generating a geometrically enhanced intensity of the detection point. Accordingly, a LiDAR device according to an embodiment may include the geometrically enhanced intensity in intensity information for a detection point to derive an image of a detection point close to a real one.

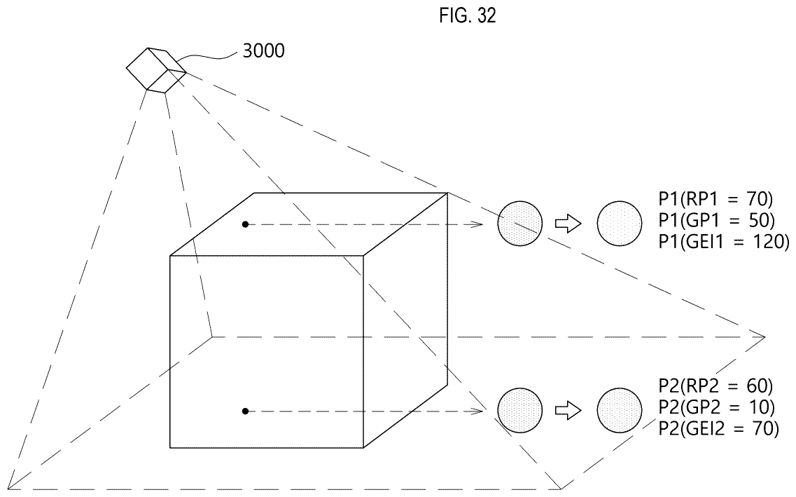

FIG. 32 is a diagram illustrating a feature of a point cloud image generated by a LiDAR device according to an embodiment on the basis of intensity information including a geometrically enhanced intensity.

Referring to FIG. 32, a LiDAR device 3000 may use two or more intensity values for the plurality of detection points to generate the point cloud image. More specifically, the LiDAR device 3000 may generate a point cloud image on the basis of at least one of the following: a reflection parameter RP, a geometrical parameter GP, and a geometrically enhanced intensity GEI for the plurality of detection points.

More preferably, the LiDAR device 3000 may generate the point cloud image using a geometrically enhanced intensity GEI for the plurality of detection points. Herein, the geometrically enhanced intensity GEI may be generated on the basis of a combination of the reflection parameter RP and the geometrical parameter GP.

For example, referring to FIG. 32, the controller of the LiDAR device 3000 may use a first reflection parameter (RP1=70) for a first detection point P1 and a second reflection parameter (RP2=60) for a second detection point P2 to visualize the first detection point P1 and the second detection point P2. In this case, distances from the LiDAR device 3000 to the first detection point P1 and the second detection point P2 and incident angles are different from each other, so the first reflection parameter (RP1=70) and the second reflection parameter (RP2=60) may have different values. Herein, the greater an incident angle of a laser emitted to a detection point, the less the degree to which the reflection parameter RP decreases. Therefore, a color of a point for a first detection point P1 generated using the first reflection parameter RP1 may be similar to a color of a point for a second detection point P2 generated using the second reflection parameter GP2.

In addition, for example, the controller of the LiDAR device 3000 may generate a first geometrically enhanced intensity (GEI1=120) by combining a first reflection parameter (RP1=70) and a first geometrical parameter (GP1=50) for the first detection point P1. In addition, the controller may generate a second geometrically enhanced intensity (GEI2=70) by combining a second reflection parameter (RP2=60) and a second geometrical parameter (GP2=10) for the second detection point P2. Herein, a difference between the first geometrical parameter GP1 and the second geometrical parameter GP2 may be greater than a difference between the first reflection parameter RP1 and the second reflection parameter RP2. This is because the LiDAR device 3000 generate the geometrical parameter GP on the basis of an incident angle of a laser emitted to a detection point and the geometrical parameter is a parameter that is more dependent on an incident angle than the reflection parameter.

In addition, in this case, the LiDAR device 3000 may visualize the first detection point P1 and the second detection point P2 on the basis of a first geometrically enhanced intensity GEI1 for the first detection point P1 and a second geometrically enhanced intensity GEI2 for the second detection point P2. Herein, a difference between the first geometrically enhanced intensity GEI1 and the second geometrically enhanced intensity GEI2 may be greater than a difference between first reflection parameter RP1 and the second reflection parameter RP2. Accordingly, a color of a point for the first detection point P1 generated using the first geometrically enhanced intensity GEI1 may be brighter than a color of a point for the second detection point P2 generated using the second geometrically enhanced intensity GEI2. In addition, a difference in color between points for the first detection point P1 and the second detection point P2 generated using a geometrically enhanced intensity GEI may be greater than a difference in color between points for the first detection point P1 and the second detection point P2 generated using the reflection parameter RP.

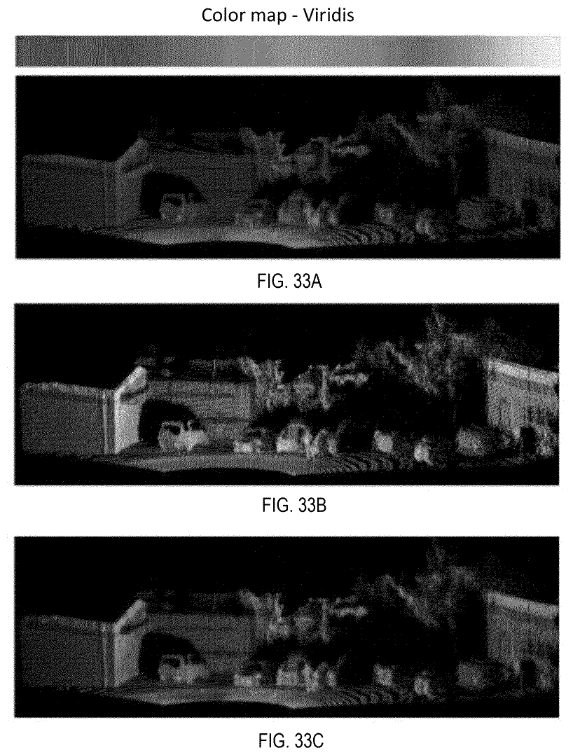

FIG. 33 is a diagram illustrating comparison of point cloud images generated on the basis of various types of intensity information by a LiDAR device according to an embodiment.

FIG. 33A shows a point cloud image generated using first intensity information including a reflection parameter.

FIG. 33B shows a point cloud image generated using second intensity information including a geometrical parameter.

FIG. 33C shows a point cloud image generated using third intensity information that includes a geometrically enhanced intensity generated by combining a reflection parameter and a geometrical parameter.

Referring to FIG. 33, a LiDAR device according to an embodiment may generate a point cloud image on the basis of various intensity values for a plurality of detection points included in a scannable area. Specifically, the LiDAR device may generate a point cloud image on the basis of at least one of the following: a reflection parameter, a geometrical parameter, and a geometrically enhanced intensity for the plurality of detection points.

Referring to FIGS. 33A and 33B, a point cloud image visualized using a geometrical parameter may reflect shape information of an object more than a point cloud image visualized using a reflection parameter. More specifically, the LiDAR device may generate a point cloud image using a geometrical parameter so that for the same object, the difference between incident angles at respective points of the same object may be represented.

In addition, referring to FIGS. 33A and 33B, a point cloud image visualized using a reflection parameter may reflect property information of an object more than a point cloud image visualized using a geometrical parameter. More specifically, a reflection parameter is proportional to the intensity of a laser scattered from an object and received by the LiDAR device, so the LiDAR device may generate a point cloud image using a reflection parameter to distinguish between a plurality of objects included in the point cloud image.

In addition, referring to FIGS. 33A and 33C, a point cloud image visualized using a geometrically enhanced intensity may reflect incident angle information of a laser emitted to an object more than a point cloud image visualized using a reflection parameter. More specifically, the LiDAR device may use a geometrically enhanced intensity to generate a point cloud image that reflects shade based on a location of a light source. In other words, incident angles of lasers emitted to a plurality of detection points for the same wall are different from each other, so a point cloud image reflecting shade may be generated using a geometrically enhanced intensity considering different pieces of incident angle information.

The above effects may be related to how much intensity information reflects incident angle information of a laser emitted to a detection point. In other words, as the intensity information reflects more incident angle information for a plurality of detection points, the LiDAR device may generate an image using the intensity information such that the plurality of detection points represent a shape close to the actual shape.

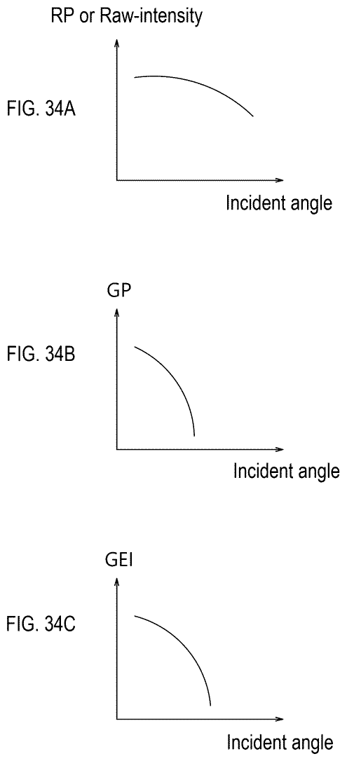

FIG. 34 is a diagram illustrating sensitivity of intensity values to an incident angle that are included in intensity information generated by a LiDAR device according to an embodiment.

A geometrically enhanced intensity GEI for a detection point generated by the LiDAR device may reflect incident angle information more than a raw intensity (or reflection parameter) for the detection point. For example, referring to FIGS. 34A and 34C, sensitivity of the geometrically enhanced intensity GEI to an incident angle may be greater than sensitivity of the reflection parameter RP or raw intensity to an incident angle. This is because the controller of the LiDAR device generates the geometrically enhanced intensity by combining a reflection parameter with low sensitivity to an incident angle and a geometrical parameter with high sensitivity to an incident angle.

In addition, a geometrically enhanced intensity GEI for a detection point generated by the LiDAR device may reflect incident angle information more than a geometrical parameter GP for the detection point. For example, referring to FIGS. 34B and 34C, sensitivity of the geometrically enhanced intensity GEI to an incident angle may be greater than sensitivity of the geometrical parameter GP to an incident angle. This is because the controller of the LiDAR device generates a geometrical parameter GP on the basis of a geometrical characteristic of a detection point and a direction of a laser emitted to a detection point and the geometrical parameter GP is a value dependent on an incident angle. However, depending on a method of calculating the geometrically enhanced intensity GEI, sensitivity of the geometrical parameter GP to an incident angle may be greater than sensitivity of the geometrically enhanced intensity GEI to an incident angle. In addition, according to an embodiment, the size of sensitivity to each incident angle may vary for each size section of an incident angle.

In addition to this, sensitivity of the geometrically enhanced intensity GEI to a distance may be greater than sensitivity of the reflection parameter RP to a distance. This is because the controller of the LiDAR device generates a geometrically enhanced intensity by combining a reflection parameter and a geometrical parameter, wherein the reflection parameter decreases as a distance increases, and similarly, the geometrical parameter decreases as a distance increases.

In addition, sensitivity of the geometrically enhanced intensity GEI to a distance may be greater than sensitivity of the geometrical parameter GP to a distance. This is because according to an embodiment, a LiDAR device is able to generate a geometrical parameter regardless of a distance to a detection point. In addition, even if the LiDAR device generates a geometrical parameter considering a distance, the geometrically enhanced intensity is generated by combining the geometrical parameter and a reflection parameter, so sensitivity of the geometrically enhanced intensity GEI to a distance may be greater than sensitivity of the geometrical parameter GP to a distance.

Hereinafter, various embodiments in which a LiDAR device uses intensity information including a geometrically enhanced intensity will be described.

5. Use of Intensity Information (1)—2D Image Generation Through Projection

A LiDAR device according to an embodiment may generate an image that reflects intensity information. Herein, the image may be expressed as various terms such as an intensity map and a point cloud image. More specifically, the controller of the LiDAR device may generate a 2D image by projecting 3D point cloud data on the basis of a predetermined algorithm.

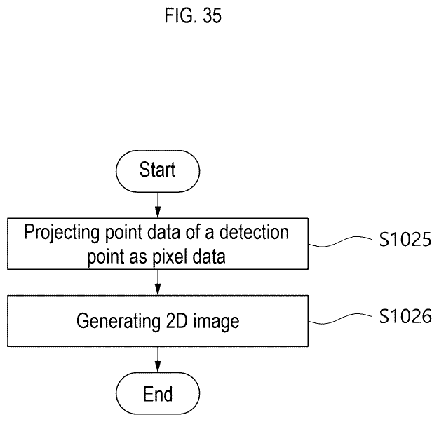

FIG. 35 is a flowchart illustrating a method of generating a 2D image by a LiDAR device according to an embodiment.

Referring to FIG. 35, the LiDAR device may project point data of a detection point as pixel data in step S1025. In addition, the LiDAR device may generate a 2D image including the pixel data in step S1026.

Herein, the point data may include intensity information for the detection point. In addition, the pixel data may be data included in a unit pixel constituting the 2D image. Accordingly, the LiDAR device may convert, on the basis of a predetermined projection algorithm, 3D point data including intensity information into a 2D image including a plurality of pieces of pixel data, but no limitation thereto is imposed.

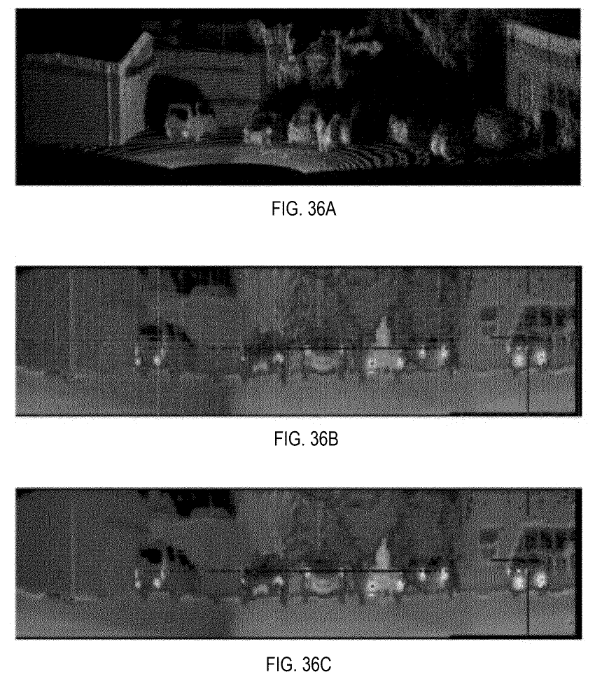

FIG. 36 is a diagram illustrating a method of generating an image with a spherical projection method by a LiDAR device according to an embodiment.

FIG. 36A is a diagram illustrating a 3D point cloud image obtained by the LiDAR device.

FIG. 36B is a diagram illustrating a spherical projection coordinate system used by the LiDAR device.

FIG. 36C is a diagram illustrating a 2D image generated by the LiDAR device on the basis of a spherical projection coordinate system.

Referring to FIGS. 36A and 36C, the LiDAR device may convert a 3D point cloud image into a 2D image. Herein, the LiDAR device may use a spherical projection coordinate system to generate a 2D image as shown in FIG. 36B. More specifically, a pixel value of the 2D image may correspond to an intensity value at a zenith and an azimuth sampled at regular intervals according to each resolution in the spherical coordinate system.

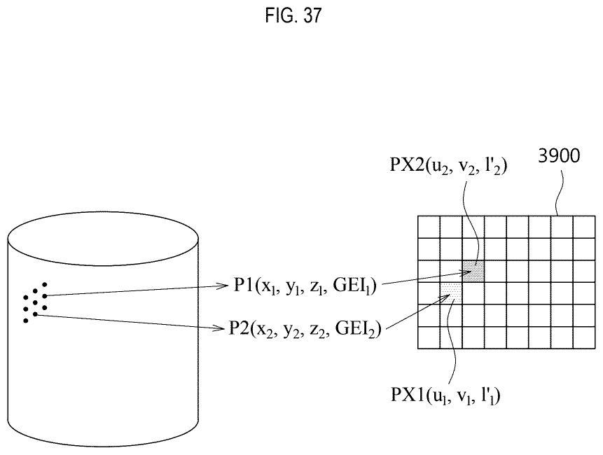

FIG. 37 is a diagram illustrating that a LiDAR device according to an embodiment generates a 2D image.

Referring to FIG. 37, a controller of a LiDAR device may convert, on the basis of a predetermined projection method, pieces of point data for a plurality of detection points into a 2D image 3900, thereby generating the 2D image 3900 for the plurality of detection points.

Herein, the 2D image 3900 may include a plurality of pieces of pixel data. For example, the 2D image 3900 may include first pixel data PX1 and second pixel data PX2.

Herein, the pixel data may be a basic unit that constitutes the 2D image 3900. Accordingly, the resolution of the 2D image 3900 may be determined depending on the number of pieces of pixel data. For example, the greater the number of pieces of pixel data constituting the 2D image, the greater the resolution of the 2D image increases and the clearer an image represented.

In addition, each of the plurality of pieces of pixel data may include pixel coordinates and a pixel value.

Herein, the pixel value may represent the intensity of the pixel data. More specifically, the 2D image 3900 may be represented on the basis of a predetermined pixel value I′ assigned to the plurality of pieces of pixel data. For example, each of the plurality of pieces of pixel data may have a pixel value I′ representing color intensity, but no limitation thereto is imposed.

In addition, the pixel coordinates may represent a location of each piece of the pixel data in the 2D image 3900. More specifically, each of the plurality of pieces of pixel data may have a location in the 2D image determined on the basis of the pixel coordinates. For example, each of the plurality of pieces of pixel data may have the pixel coordinates (u,v) represented in a 2D rectangular coordinate system, but no limitation thereto is imposed.

Accordingly, the controller of the LiDAR device may generate the 2D image 3900 by determining pixel coordinates (u,v) and a pixel value I′ of a plurality of pieces of pixel data corresponding to each of a plurality of pieces of point data included in point cloud data.

For example, the controller of the LiDAR device may project point data for a first detection point P1 and a second detection point P2 as first pixel data PX1 and second pixel data PX2, respectively, thereby generating a 2D image including the first pixel data PX1(u1,v1,I′1) and the second pixel data PX2(u2,v2,I′2).

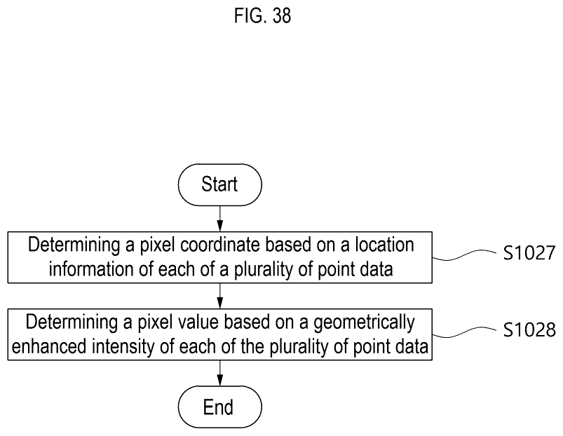

FIG. 38 is a diagram illustrating that a LiDAR device according to an embodiment determines pixel data for generating an image.

Referring to FIG. 38, a controller of a LiDAR device may determine pixel coordinates of pixel data on the basis of location information of each of a plurality of pieces of point data in step S1027.

More specifically, the controller may convert location coordinates included in location information of the plurality of pieces of point data into 2D pixel coordinates on the basis of a predetermined coordinate system conversion algorithm.

For example, referring back to FIG. 37, the controller may convert (x1,y1,z1), which is location information of the first detection point P1, into a coordinate system using a spherical projection method, and may match a result of conversion to first pixel data PX1 having first pixel coordinates (u1,v1) in the 2D image 3900. In addition, the controller may convert (x2,y2,z2), which is location information of the second detection point P2, into a coordinate system using a spherical projection method, and may match a result of conversion to second pixel data PX2 having second pixel coordinates (u2,v2) in the 2D image 3900.

In addition, the controller of the LiDAR device may determine a pixel value on the basis of a geometrically enhanced intensity of each of the plurality of pieces of point data in step S1028.

More specifically, the controller may determine a pixel value of pixel data on the basis of a geometrically enhanced-intensity value included in intensity information of the plurality of pieces of point data. For example, the controller may set pixel values of a plurality of pieces of pixel data respectively corresponding to the plurality of pieces of point data by using a geometrically enhanced intensity for the plurality of pieces of point data, but no limitation thereto is imposed. The controller may set, as the pixel value, a value obtained by processing the geometrically enhanced intensity on the basis of a predetermined method.

For example, referring back to FIG. 37, the controller may determine a first pixel value I′1 of the first pixel data PX1 on the basis of a first geometrically enhanced intensity GEI1 included in intensity information of the first detection point P1. Herein, the first pixel value I′1 and the geometrically enhanced intensity GEI1 may be the same value, but no limitation thereto is imposed. In addition, the controller may determine a second pixel value I′2 of the second pixel data PX2 on the basis of a second geometrically enhanced intensity GEI2 included in intensity information of the second detection point P2. Herein, the second pixel value I′2 and the geometrically enhanced intensity GEI2 may be the same value, but no limitation thereto is imposed.

In this case, the color of each piece of pixel data constituting the 2D image 3900 may be determined depending on the pixel values of the plurality of pieces of pixel data. More specifically, the greater the pixel value of the pixel data, the brighter the color in which the pixel data is visualized. For example, when the first pixel value I′1 of the first pixel data PX1 is smaller than the second pixel value I′2 of the second pixel data PX2, the first pixel data PX1 may represent a darker color than the second pixel data PX2, but no limitation thereto is imposed.

In addition, although FIG. 37 shows that a detection point and pixel data are matched 1:1, but no limitation thereto is imposed, and may be matched n:1 or 1:n.

More specifically, among a plurality of detection points measured by the LiDAR device, at least two detection points may be matched to one piece of pixel data in an image. For example, the controller of the LiDAR device may project, on the basis of bilinear interpolation, pieces of point data for two or more detection points onto one piece of pixel data, but no limitation thereto is imposed.

In addition, no limitation thereto is imposed, one detection point may be matched to two or more pieces of pixel data in the image. For example, in order to increase resolution of an image, the controller of the LiDAR device may separate point data for one detection point into two or more pieces of pixel data for projection, but no limitation thereto is imposed.

6. Use of Intensity Information (2)—Image Generation Using a Plurality of Parameters

A LiDAR device according to another embodiment may generate an image using a plurality of parameters that are obtained in a process of generating a geometrically enhanced intensity.

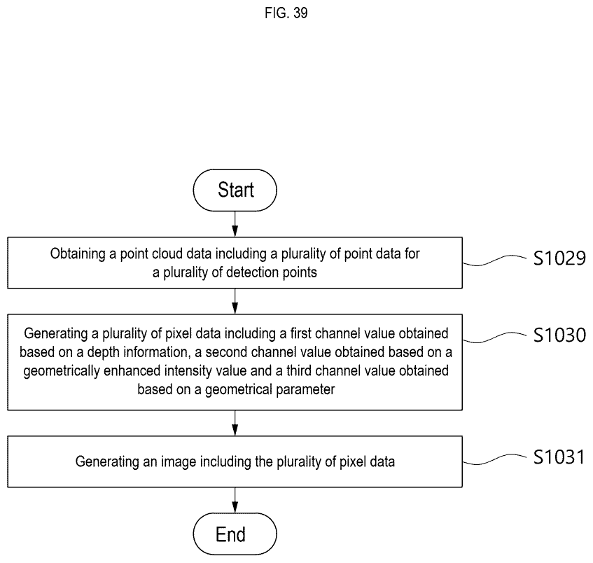

FIG. 39 is a flowchart illustrating a method of generating an image by a LiDAR device according to another embodiment.

Referring to FIG. 39, a controller of a LiDAR device may obtain point cloud data including a plurality of pieces of point data for a plurality of detection points in step S1029. In addition, the controller may generate a plurality of pieces of pixel data including a first channel value obtained on the basis of depth information, a second channel value obtained on the basis of a geometrically enhanced intensity, and a third channel value obtained on the basis of a geometrical parameter in step S1030. In addition, the controller may generate an image including the plurality of pieces of pixel data in step S1031.

The controller may generate an image that represent various types of information for a detection point. More specifically, the controller may generate an image that includes intensity information of the detection point as well as information, such as saturation or brightness, of the detection point. Accordingly, the controller may generate pixel data including a plurality of channel values. Specifically, the pixel data has a pixel value, and the pixel value of the pixel data may be generated to include a plurality of channel values. For example, a pixel value of the pixel data may have a first channel value, a second channel value, and a third channel value, but is not limited thereto.

For example, the controller may generate an image such that pixel data has a first channel value obtained on the basis of depth information. Herein, the depth information may include distance information from the LiDAR device to a detection point. In addition, as the controller generates an image on the basis of the depth information, the image may include saturation information of the detection point. For example, when the first channel value increase as depth information of a predetermined detection point increases, saturation of the predetermined detection point represented in an image may decrease. In other words, sharpness of the predetermined detection point in the image may decrease. This is because the longer a distance from the LiDAR device, the less clearly a detection point is viewed in an image.

In addition, the controller may generate an image such that pixel data has a second channel value obtained on the basis of a geometrically enhanced intensity. In addition, as the controller generates an image on the basis of the geometrically enhanced intensity, the image may include color information of the detection point. For example, when the second channel value increases as a geometrically enhanced intensity of a predetermined detection point increases, color of the predetermined detection point represented in an image may be close to white. This is because the more a detection point has a reflection characteristic of reflecting light well, the more the detection point represented in an image is viewed in a color close to white.

In addition, no limitation thereto is imposed, the controller may generate an image such that pixel data has the second channel value on the basis of a corrected intensity. This is because in order to represent color of an image through the second channel value, the LiDAR device is able to generate an image using a reflection characteristic of a detection point determined depending on a property of the detection point. For example, when a predetermined detection point is included in a highly reflective object, as a corrected intensity of the predetermined detection point increases, color of the predetermined detection point represented in the image may be represented in a color close to white.

In addition, the controller may generate an image such that pixel data has a third channel value obtained on the basis of a geometrical parameter. In addition, as the controller generates an image on the basis of the geometrical parameter, the image may include brightness information of the detection point. For example, when an incident angle of a laser emitted to a predetermined detection point increases, a geometrical parameter for the predetermined detection point increases. Accordingly, when the third channel value increases, brightness of the predetermined detection point represented in an image may increase. In other words, brightness of the predetermined detection point in the image may increase. This is because the LiDAR device generates a geometrical parameter on the basis of an emission direction of a laser and a geometrical characteristic of a predetermined detection point, so the smaller an incident angle of a laser emitted to the predetermined detection point, the greater a geometrical parameter generated by the LiDAR device.

7. Use of Intensity Information (3)—Correction of Distance Information

A LiDAR device according to an embodiment may obtain different pieces of distance information for a plurality of objects present at the same distance. This is because as the plurality of objects have different properties, pieces of intensity information for the plurality of objects are different from each other, and thus pulse widths of detection signals for the plurality of objects are different from each other.

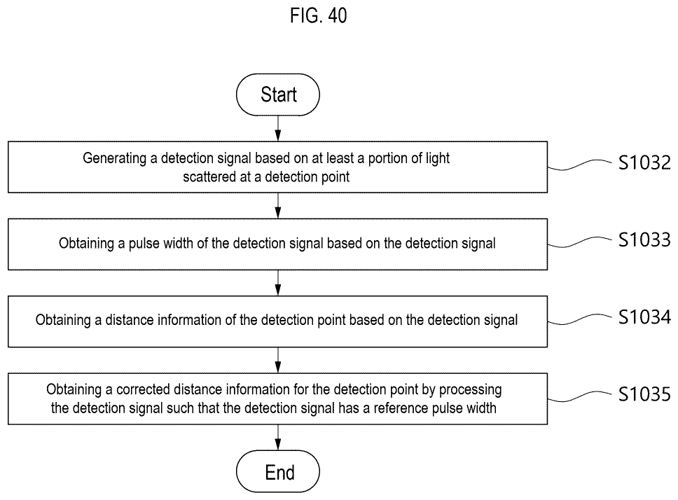

FIG. 40 is a flowchart illustrating a method of correcting distance information on the basis of intensity information by an LiDAR device according to an embodiment.

Referring to FIG. 40, a LiDAR device according to an embodiment may generate a detection signal on the basis of at least a portion of light scattered at a detection point in step S1032.

In addition, the controller of the LiDAR device may obtain a pulse width of the detection signal on the basis of the detection signal in step S1033. In this case, the controller may obtain a pulse width of the detection signal by calculating a width of the detection signal when an amplitude of the detection signal is equal to a first threshold value. In addition, the controller may generate intensity information for the detection point on the basis of a pulse width of the detection signal. Herein, the intensity information may include a raw intensity for the detection point, but is not limited thereto. The intensity information may include a corrected intensity for the detection point and a geometrically enhanced intensity for the detection point.

In addition, the controller may obtain distance information of the detection point on the basis of the detection signal in step S1034. In this case, the controller may obtain distance information of the detection point by calculating the time when an amplitude of the detection signal is equal to the first threshold value or the second threshold value.

In addition, the controller may obtain corrected distance information for the detection point by processing the detection signal such that the detection signal has a reference pulse width in step S1035. More specifically, in order to obtain the same distance information for detection points present at the same distance, the controller may process the detection signal such that a pulse width of the detection signal corresponds to the reference pulse width. In other words, regardless of the actual profile of the detection signal, the controller may arbitrarily change the detection signal such that the detection signal has the reference pulse width. For example, as all detection signals are changed to have the same reference pulse width, in the case of detection points present at the same distance, the controller may obtain the same corrected distance information for the detection points regardless of reflection characteristics of the detection points, but no limitation thereto is imposed.

The method according to the embodiment may be implemented in the form of program instructions that can be executed through various computer means and recorded in a computer-readable medium. The computer-readable medium may include program instructions, data files, data structures, etc. alone or in combination. The program instructions recorded in the medium may be specially designed and configured for embodiments, or may be known and usable to those skilled in computer software. Examples of computer-readable recording media include hardware devices specially configured to store and execute program instructions, for example, magnetic media such as hard disks, floppy disks and magnetic tapes, optical media such as CD-ROM and DVD, magneto-optical media such as a floptical disk, and ROM, RAM, flash memory, etc. Examples of the program instructions include not only machine language codes such as those produced by a compiler, but also high-level language codes that can be executed by a computer using an interpreter or the like. The above-described hardware device may be configured to operate as one or more software modules to perform the operation of an embodiment, and vice versa.

Although the present disclosure has been described with reference to specific embodiments and drawings, it will be appreciated that various modifications and changes can be made from the disclosure by those skilled in the art. For example, appropriate results may be achieved although the described techniques are performed in an order different from that described above and/or although the described components such as a system, a structure, a device, or a circuit are combined in a manner different from that described above and/or replaced or supplemented by other components or their equivalents.

Therefore, other implementations, embodiments, and equivalents are within the scope of the following claims.

### MODE FOR INVENTION

As described above, in the best mode for carrying out the invention, related matters have been described.

1. A method for processing point data obtained from a light detection and ranging (LiDAR) device, comprising:
obtaining a point cloud data including a plurality of point data for a plurality of detection points; and
generating an image for the plurality of detection points based on the point cloud data,
wherein each of the plurality of point data comprises:
location information for a detection point; and
a geometrically enhanced intensity for the detection point,
wherein the geometrically enhanced intensity is generated based on a combination of a reflection parameter related to an amount of light scattered at the detection point and a geometrical parameter based on a geometrical characteristic of the detection point,
wherein the reflection parameter is obtained based on a detection signal generated by the LiDAR device based on at least a part of the light scattered at the detection point,
wherein the geometrical characteristic is obtained based on location information for a group of detection points determined based on the location information for the detection point,
wherein the group of detection points include the detection point and at least a part of another detection point around the detection point, and
wherein the geometrically enhanced intensity is proportional to the reflection parameter and the geometrical parameter.

2. The method of claim 1, wherein the location information for the detection point reflects a distance between the LiDAR device and the detection point.

3. The method of claim 1, wherein the location information for the detection point is generated based on a detection time point of the detection signal and a light emission time point of the LiDAR device.

4. The method of claim 1, wherein the reflection parameter is obtained based on a characteristic of the detection signal, and wherein the characteristic of the detection signal includes at least one of a pulse width of the detection signal, a rising edge of the detection signal, a falling edge of the detection signal, or a pulse area of the detection signal.

5. The method of claim 1, wherein the detection signal is generated by detecting at least a portion of laser scattered at the detection point when the laser emitted from the LiDAR device reaches the detection point.

6. The method of claim 1, wherein the geometrical characteristic of the detection point is generated based on a normal vector corresponding to a virtual plane, and wherein the virtual plane is formed based on the location information of the group of detection point.

7. The method of claim 1, wherein the geometrical characteristic of the detection point reflects a geometrical shape formed by the group of detection points.

8. The method of claim 6, wherein the geometrical parameter is obtained based on the geometrical characteristic and a direction vector of laser emitted from the LiDAR device towards the detection point.

9. The method of claim 1, wherein the reflection parameter depends on an intrinsic property of the detection point and a distance between the LiDAR device and the detection point.

10. The method of claim 1, wherein the combination of the reflection parameter and the geometrical parameter is performed such that a numerical range of the geometrically enhanced intensity is equal to a numerical range of the reflection parameter.

11. The method of claim 1, wherein the reflection parameter and the geometrical parameter are normalized based on the same numerical range.

12. The method of claim 1, wherein the combination of the reflection parameter and the geometrical parameter is a linear combination of the reflection parameter and the geometrical parameter.

13. The method of claim 1, wherein the combination of the reflection parameter and the geometrical parameter is performed by assigning a weight to each of the reflection parameter and the geometrical parameter.

14. The method of claim 13, wherein a weight for the reflection parameter and a weight for the geometrical parameter are determined such that a sum of the weight for the reflection parameter and the weight for the geometrical parameter is constant.

15. The method of claim 13, wherein each of a weight for the reflection parameter and a weight for the geometrical parameter is determined based on a property information of a set of point data including a point data for the detection point.

16. The method of claim 1, wherein the image includes a plurality of pixel data corresponding to the plurality of point data, wherein a pixel coordinate of each of the plurality of pixel data is determined based on the location information of each of the plurality of point data, and wherein a pixel value of each of the plurality of pixel data is determined based on the geometrically enhanced intensity of each of the plurality of point data.

17. The method of claim 1, wherein generating the image comprises:
projecting the point data of the detection point to a pixel data, wherein a value of the pixel data corresponds to the geometrically enhanced intensity; and
generating the image including a plurality of pixel data by performing the projection for each of the plurality of point data for the plurality of detection points.

18. A method for processing point data obtained from a light detection and ranging (LiDAR) device, comprising:
obtaining location information for a detection point;
for the detection point, obtaining a first intensity based on a detection signal corresponding to the detection point;
for the detection point, generating a second intensity based on location information for a group of one or more detection points determined based on the location information for the detection point; and
for the detection point, generating a third intensity based on a combination of the first intensity and the second intensity,
wherein the third intensity is proportional to the first intensity and the second intensity.

19. The method of claim 18, wherein the location information for the detection point and the third intensity is used to generate an image for a plurality of detection points including the detection point.

20. A method for processing point data obtained from a light detection and ranging (LiDAR) device, comprising:
obtaining location information for a detection point;
for the detection point, obtaining a first intensity based on a detection signal corresponding to the detection point;
for the detection point, generating a second intensity based on location information for a group of one or more detection points determined based on the location information for the detection point; and
for the detection point, generating a third intensity based on a combination of the first intensity and the second intensity,
wherein the first intensity and the second intensity are normalized based on the same numerical range.

21. A non-transitory computer-readable recording medium for storing instructions, when executed by one or more processors, configured to perform the method of claim 1.
